(19) United States
(12) Patent Application Publication
(10) Pub. No.: US 2022/0264080 A1
(43) Pub. Date: Aug. 18, 2022

(54) SYSTEM AND METHOD FOR ADAPTIVE LENSLET LIGHT FIELD TRANSMISSION AND RENDERING

(71) Applicant: PCMS Holdings, Inc., Wilmington, DE (US)

(72) Inventors: Tatu V. J. Harviainen, Helsinki (FI); Louis Kerofsky, San Diego, CA (US)

(21) Appl. No.: 17/628,532

(22) PCT Filed: Jul. 20, 2020
(86) PCT No.: PCT/US2020/042756

§ 371 Date: Jan. 19, 2022

Related U.S. Application Data
(60) Provisional application No. 62/877,574, filed on Jul. 23, 2019.

(51) Int. Cl. H04N 13/383; H04N 13/307; H04N 13/117

(52) U.S. Cl. CPC H04N 13/383; H04N 13/117; H04N 13/307

(57) ABSTRACT

Some embodiments of a method may include: streaming a light field lenslet representation of light field video content; and changing resolution of the light field lenslet representation. Some embodiments of a method may include: selecting a lenslet representation from a plurality of lenslet representations of portions of light field content; retrieving a sub-sampled lenslet representation of the selected lenslet representation; and interpolating views from the sub-sampled lenslet representation.

### CROSS-REFERENCE TO RELATED APPLICATIONS

The present application is a non-provisional filing of, and claims benefit under 35 U.S.C. § 119(e) from, U.S. Provisional Patent Application Ser. No. 62/877,574, entitled “SYSTEM AND METHOD FOR ADAPTIVE LENSLET LIGHT FIELD TRANSMISSION AND RENDERING” and filed Jul. 23, 2019, which is hereby incorporated by reference in its entirety.

### BACKGROUND

A high-fidelity light field, as a representation of a 3D scene, may contain huge amount of data. In order to support real-time transmission and visualization, efficient data distribution optimization methods may be used. For compressing traditional 2D video, various lossless and lossy bitrate reduction and compression methods have been developed.

### SUMMARY

An example method in accordance with some embodiments may include: receiving, from a server, a media manifest file describing a plurality of sub-sampled lenslet representations of portions of light field video content; selecting a sub-sampled lenslet representation from the plurality of sub-sampled lenslet representations; retrieving the selected sub-sampled lenslet representation from the server; interpolating views from the retrieved selected sub-sampled lenslet representation using the description of the selected sub-sampled lenslet representation in the manifest file; and displaying the interpolated views.

Some embodiments of the example method may further include determining an estimated bandwidth available for streaming the light field video content.

For some embodiments of the example method, selecting the sub-sampled lenslet representation may select the sub-sampled lenslet representation based on at least one of: a viewpoint of a user, an estimated bandwidth, or a display capability of a viewing client.

Some embodiments of the example method may further include predicting a predicted viewpoint of the user, such that the viewpoint of the user is the predicted viewpoint of the user.

For some embodiments of the example method, selecting the sub-sampled lenslet representation may include: determining a respective minimum supported bandwidth for at least one of the plurality of sub-sampled lenslet representations; and selecting the sub-sampled lenslet representation with a largest minimum supported bandwidth of the plurality of respective minimum supported bandwidths less than the estimated bandwidth.

Some embodiments of the example method may further include determining an estimated maximum content size supported by the estimated bandwidth, such that selecting the sub-sampled lenslet representation may select one of the plurality of sub-sampled lenslet representations with a content size less than the estimated maximum content size.

Some embodiments of the example method may further include: tracking a direction of gaze of a user, such that selecting the sub-sampled lenslet representation uses the direction of gaze of the user.

For some embodiments of the example method, selecting the sub-sampled lenslet representation may include selecting a sub-sampled lenslet representation with a density above a density threshold for portions of the light field content located within a gaze threshold of the direction of gaze of the user.

Some embodiments of the example method may further include: predicting a viewpoint of a user; and adjusting the selected lenslet representation for the predicted viewpoint.

Some embodiments of the example method may further include: selecting a light field spatial resolution; dividing the light field content into portions corresponding to the light field spatial resolution; and selecting a lenslet image for at least one frame of at least one sub-sampling lenslet representation of at least one portion of the light field content, such that selecting the sub-sampled lenslet representation may select a respective sub-sampling lenslet representation for at least one portion of the light field content, and such that interpolating views from the sub-sampled lenslet representation may use the respective lenslet image.

Some embodiments of the example method may further include adjusting the light field spatial resolution to improve a performance metric of the interpolated views.

For some embodiments of the example method, interpolating views from the retrieved sub-sampled lenslet representation may include: unpacking the retrieved sub-sampled lenslet representation into original lenslet locations of the portion of light field video content indicated in the manifest file; and interpolating lenslet samples omitted from the retrieved sub-sampled lenslet representation.

For some embodiments of the example method, interpolating views from the retrieved sub-sampled lenslet representation may generate a complete light field region image for the portion of the light field video content.

For some embodiments of the example method, selecting the sub-sampled lenslet representation may select the sub-sampled lenslet representation based on at least one of: a density of the selected sub-sampled lenslet representation, or a range of the selected sub-sampled lenslet representation.

An example apparatus in accordance with some embodiments may include: a processor; and a non-transitory computer-readable medium storing instructions that are operative, when executed by the processor, to perform the method of any one of claims listed above.

An example method in accordance with some embodiments may include: selecting a lenslet representation from a plurality of lenslet representations of portions of light field content described in a media manifest file; retrieving, from a server, a sub-sampled lenslet representation of the selected lenslet representation; and interpolating views from the sub-sampled lenslet representation.

Some embodiments of the example method may further include: retrieving a media manifest file describing a plurality of lenslet representations of portions of light field video content; and displaying the interpolated views.

For some embodiments of the example method, interpolating the views from the retrieved sub-sampled lenslet representation may use the description of the lenslet representation in the manifest file.

Some embodiments of the example method may further include: determining an estimated bandwidth between a client and a server, such that selecting the lenslet representation may use the estimated bandwidth.

For some embodiments of the example method, the description of at least one of the plurality of lenslet representations may include information regarding at least one of range or density of the respective lenslet representation.

For some embodiments of the example method, selecting the sub-sampled lenslet representation may include selecting a sub-sampled lenslet representation with a highest range.

For some embodiments of the example method, selecting the sub-sampled lenslet representation may include selecting a sub-sampled lenslet representation with a highest density.

For some embodiments of the example method, selecting the lenslet representation may use a capability of a client.

For some embodiments of the example method, selecting the sub-sampled lenslet representation may include selecting a sub-sampled lenslet representation with a density above a threshold supported by the client.

For some embodiments of the example method, the capability of the client may be a maximum lenslet density supported by the client.

For some embodiments of the example method, interpolating views from the sub-sampled lenslet representation may use the description of the lenslet representation in the manifest file.

Some embodiments of the example method may further include: updating a viewpoint of a user; and adjusting the selected lenslet representation for the updated viewpoint.

Some embodiments of the example method may further include: predicting a viewpoint of the user, such that selecting the sub-sampled lenslet representation may include selecting a sub-sampled lenslet representation with a density above a threshold for portions of the light field content located within a threshold of the predicted viewpoint.

Some embodiments of the example method may further include selecting a sub-sampling rate for the selected lenslet representation.

Some embodiments of the example method may further include estimating bandwidth available for streaming light field video content, such that selecting the sub-sampling rate may use the estimated bandwidth available.

Some embodiments of the example method may further include: selecting a lenslet image for each frame of each sub-sampling lenslet representation of each portion of the light field content, such that selecting the lenslet representation from the plurality of lenslet representations selects a respective sub-sampling lenslet representation for each portion of the light field content, such that interpolating views from the sub-sampled lenslet representation uses the respective lenslet image, and such that selecting the lenslet image selects the lenslet image from a plurality of lenslet images based on an estimated quality of interpolation results.

Some embodiments of the example method may further include determining a respective estimated quality of interpolation results for the plurality of lenslet images, such that selecting the lenslet image selects the lenslet image based on which lenslet image of the plurality of lenslet images has a highest determined respective estimated quality of interpolation results.

An example apparatus in accordance with some embodiments may include: a processor; and a non-transitory computer-readable medium storing instructions that are operative, when executed by the processor, to perform any of the methods listed above.

An example method in accordance with some embodiments may include: streaming a light field lenslet representation of light field video content; and changing resolution of the light field lenslet representation.

An example apparatus in accordance with some embodiments may include: a processor; and a non-transitory computer-readable medium storing instructions that are operative, when executed by the processor, to perform any of the methods listed above.

An example method in accordance with some embodiments may include: selecting a lenslet representation from a plurality of lenslet representations of portions of light field content; retrieving a sub-sampled lenslet representation of the selected lenslet representation; and interpolating views from the sub-sampled lenslet representation to reconstruct lenslet samples missing in the sub-sampled representation.

An example apparatus in accordance with some embodiments may include: a processor; and a non-transitory computer-readable medium storing instructions that are operative, when executed by the processor, to perform any of the methods listed above.

An example method in accordance with some embodiments may include: retrieving a sub-sampled lenslet representation of light field content; and reconstructing lenslet samples omitted from the sub-sampled lenslet representation by interpolating the retrieved sub-sampled lenslet representation.

An example apparatus in accordance with some embodiments may include: a processor; and a non-transitory computer-readable medium storing instructions that are operative, when executed by the processor, to perform any of the methods listed above.

An example method in accordance with some embodiments may include: sending a media manifest file describing a plurality of sub-sampled lenslet representations of portions of light field video content; receiving information indicating a sub-sampled lenslet representation selected from the plurality of sub-sampled lenslet representations; and sending the selected sub-sampled lenslet representation.

An example apparatus in accordance with some embodiments may include: a processor; and a non-transitory computer-readable medium storing instructions that are operative, when executed by the processor, to perform any of the methods listed above.

An example apparatus in accordance with some embodiments may include: a processor; and a non-transitory computer-readable medium storing instructions that are operative, when executed by the processor, to: send a media manifest file describing a plurality of sub-sampled lenslet representations of portions of light field video content; receive information indicating a sub-sampled lenslet representation selected from the plurality of sub-sampled lenslet representations; and send the selected sub-sampled lenslet representation.

### BRIEF DESCRIPTION OF THE DRAWINGS

FIG. 1A is a system diagram illustrating an example communications system according to some embodiments.

FIG. 1B is a system diagram illustrating an example wireless transmit/receive unit (WTRU) that may be used within the communications system illustrated in FIG. 1A according to some embodiments.

FIG. 2 is a schematic illustration showing an example full light field rendered with 5×5 sub-views according to some embodiments.

FIG. 3A is a schematic illustration showing an example lenslet representation according to some embodiments.

FIG. 3B is a schematic illustration showing an example view array representation according to some embodiments.

FIGS. 4A-4B are schematic illustrations showing examples of light field data in lenslet format according to some embodiments.

FIG. 5 is a system diagram illustrating an example set of interfaces for a viewing client according to some embodiments.

FIG. 6 is a message sequencing diagram illustrating an example process for a typical session sequence according to some embodiments.

FIGS. 7A-7B are a flowchart illustrating an example process for a content server process according to some embodiments.

FIG. 8 is a schematic illustration showing an example full lenslet light field divided into regions according to some embodiments.

FIGS. 9A-9C are schematic illustrations showing example sub-sampling sets with varying sub-sampling densities at a first time step according to some embodiments.

FIGS. 10A-10C are schematic illustrations showing example sub-sampling sets with varying sub-sampling densities at a second time step according to some embodiments.

FIGS. 11A-11C are schematic illustrations showing example sub-views selected for sub-sampling sets packed as dense integral images according to some embodiments.

FIG. 12 is a data structure diagram illustrating an example MPEG-DASH Media Presentation Description (MPD) according to some embodiments.

FIG. 13 is a data structure diagram illustrating an example Media Presentation Description (MPD) with example lenslet light field description(s), sub-sampling sets, resolutions, and bitrates according to some embodiments.

FIG. 14 is a process diagram illustrating an example lenslet array reconstruction process according to some embodiments.

FIG. 15 is a flowchart illustrating an example process for a viewing client according to some embodiments.

FIG. 16A is a schematic illustration showing an example multi view array representation according to some embodiments.

FIG. 16B is a schematic illustration showing an example full lenslet representation according to some embodiments.

FIG. 17A is a schematic illustration showing an example multi view array representation with ROI illustrated according to some embodiments.

FIG. 17B is a schematic illustration showing an example full lenslet representation with ROI illustrated according to some embodiments.

FIG. 18A is a schematic illustration showing an example multi view array representation with ROI illustrated and selected views according to some embodiments.

FIG. 18B is a schematic illustration showing an example full lenslet representation with ROI illustrated according to some embodiments.

FIG. 19 is a process diagram illustrating an example sub-sampling process for selecting lenslet views according to some embodiments.

FIG. 20 is an image illustration showing an example full lenslet image with 425×425 samples and 5×5 views according to some embodiments.

FIG. 21 is an image illustration showing an example sub-sampled lenslet image with 255×255 samples and 3×3 views according to some embodiments.

FIG. 22 is an image illustration showing an example sub-sampled lenslet image with 255×85 samples and 1×3 views according to some embodiments.

FIG. 23 is an image illustration showing an example sub-sampled lenslet image with 85×85 samples and 1×1 views according to some embodiments.

FIGS. 24A-24C are schematic illustrations showing an example lenslet light field sub-sampled with two sub-sampling densities according to some embodiments.

FIG. 25 is a message sequencing diagram illustrating an example process for adaptive light field streaming using estimated bandwidth and view interpolation according to some embodiments.

FIG. 26 is a flowchart illustrating an example process for a viewing client according to some embodiments.

FIG. 27 is a flowchart illustrating an example process for a viewing client according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### DETAILED DESCRIPTION

A wireless transmit/receive unit (WTRU) may be used, e.g., as a viewing client, a content server, a sensor, or a display, in some embodiments described herein.

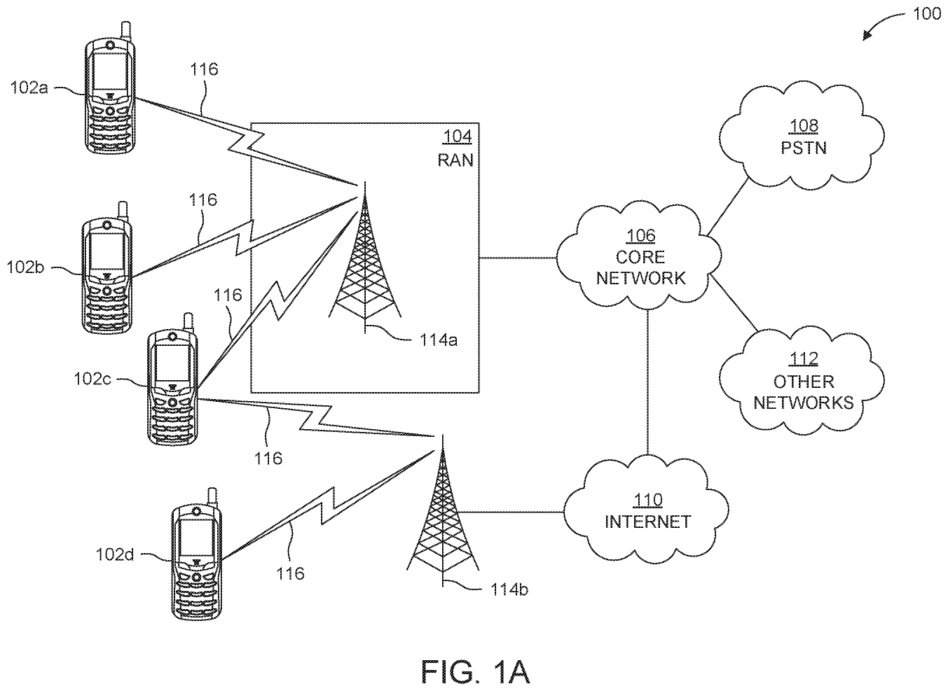

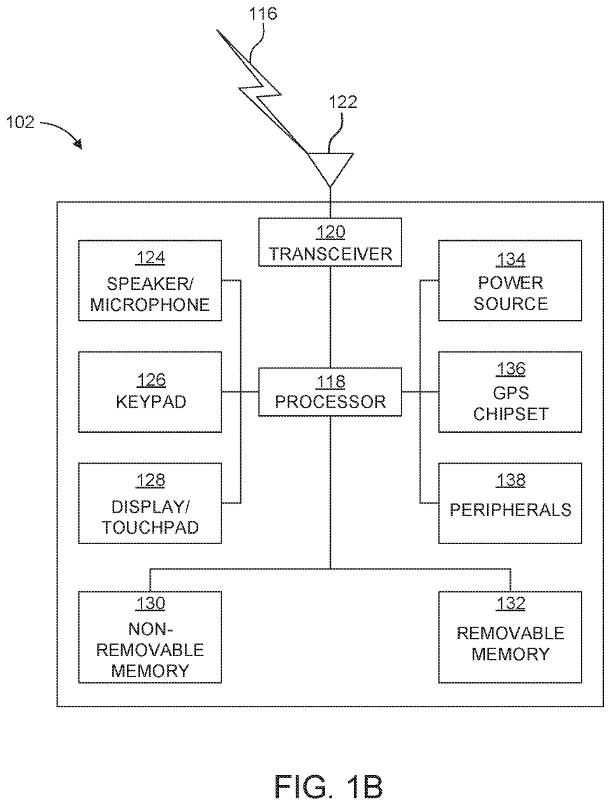

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104/113 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, errortolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106 may be in direct or indirect communication with other RANs that employ the same RAT as the RAN 104/113 or a different RAT. For example, in addition to being connected to the RAN 104/113, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

In view of FIGS. 1A-1B, and the corresponding description of FIGS. 1A-1B, one or more, or all, of the functions described herein with regard to one or more of: WTRU 102a-d, Base Station 114a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In addition to spatio-temporal compression methods, one class of bitrate reduction methods sends parts of the information integrally, multiplexed over time. With CRT displays, multiplexing was used widely by interlacing image lines in analog TV transmissions. Another class of compression algorithms use various prediction methods, typically made on both the transmission side (encoder or server) and the receiving side (decoder). These predictions may be both spatial (intra frame) or temporal (inter frame).

Some of these algorithms have been used with light fields. For example, the article Kara, Peter A., et al., Evaluation of the Concept of Dynamic Adaptive Streaming of Light Field Video, 64(2) IEEE TRANSACTIONS ON BROADCASTING 407-421 (2018) is understood to describe how subjective quality of light field renderings are affected by quality switching and stalling (frame freezing) approaches and balancing between associated tradeoffs between transfer bitrate, light field angular resolution, and spatial resolution.

In general, methods applying predictive coding methods to real-time transmission of light fields are still rare. An example of these methods is understood to be described in the article Ebrahimi, Touradj, et al., JPEG Pleno: Toward an Efficient Representation of Visual Reality, 23(4) IEEE MULTIMEDIA 14-20 (October-December 2016) (“Ebrahimi”) regarding light field compression. This proposal is understood to describe how existing multi-view coding methods (e.g., MPEG HEVC or 3D HEVC) may be used for the compression of light fields. 3D HEVC is an extension of HEVC for supporting depth images.

Much of the work done on light field compression focuses on multi-view image array-type light field formats, such that the light field data consists of a number of views of the full scene captured with varying viewpoints. In existing multi-view coding standards, all views may generally need to be decoded even when only a particular sub-view is being viewed, as understood to be disclosed by Sullivan, Gary J., et al., Standardized Extensions of High Efficiency Video Coding (HEVC), 7(6) IEEE J. SELECTED TOPICS IN SIGNAL PROC. (December 2013). Correspondingly, decoding only one sub-view at a time, or multiple sub-views in parallel, may not be possible due to data dependency among sub-views.

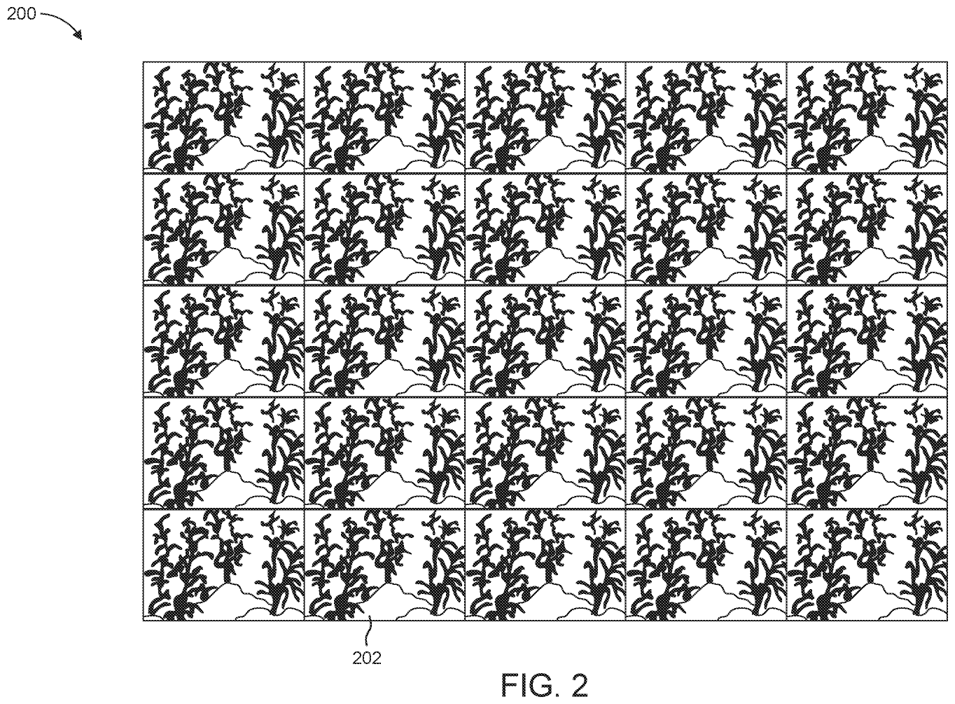

FIG. 2 is a schematic illustration showing an example full light field rendered with 5×5 sub-views according to some embodiments. In FIG. 2, a full light field is rendered with a 5×5 virtual camera array 200. FIG. 2 shows an example multi-view light field with a 5×5 array of full views 202.

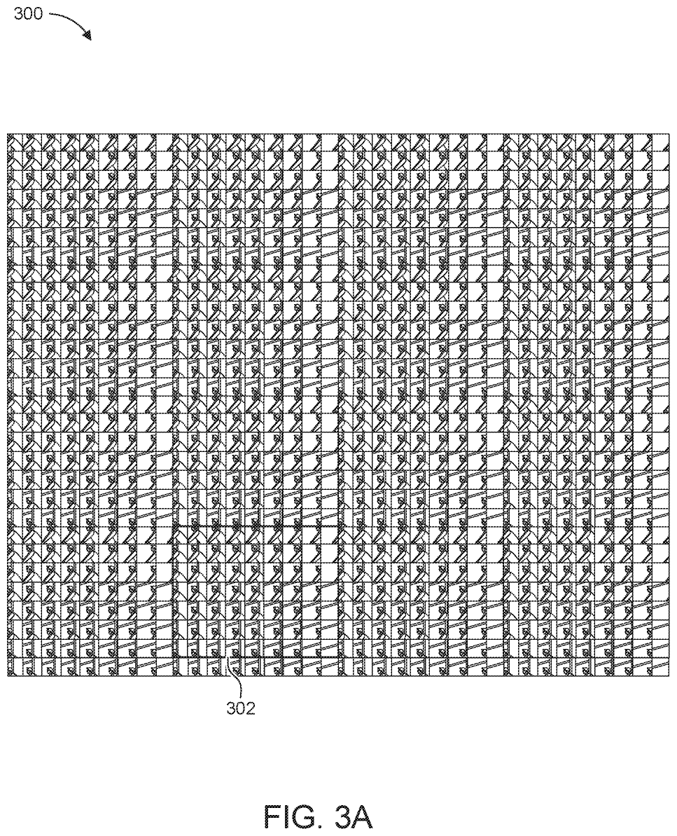

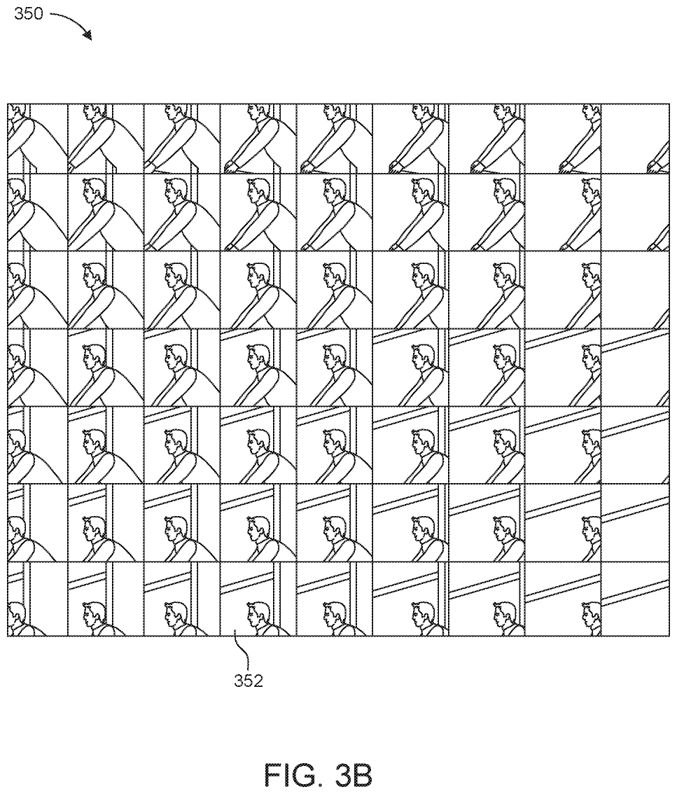

FIG. 3A is a schematic illustration showing an example lenslet representation according to some embodiments. FIG. 3B is a schematic illustration showing an example view array representation according to some embodiments. FIG. 3A shows an example of a full lenslet light field representation 300 and a region 302 that is portion of the full lenslet light field representation 300. The example region 302 in FIG. 3A is shown in more detail in FIG. 3B. FIG. 3B shows example individual sub-views 352 corresponding to the example region 302, 350. For some embodiments, such as the example shown in FIG. 3B, sub-views 352 of the scene are taken with different viewpoints at the same point in time.

Display technologies enabling free-viewpoint viewing of video content are emerging. Light fields used by these displays produce vast amounts of data. Rendering and transmission of light field data may become bottlenecks. Data optimization may be used to avoid such bottlenecks. Resolution and frame rate are two aspects of a video sequence which may be adapted to enable content streaming via DASH.

Many adaptive video streaming devices do not use the angular aspects of light field content. One question that may arise is how may view adaptation be used in streaming video content represented as interleaved “lenslet” images. Spatial tiled-based streaming extracts all viewing directions for a subset of the content rather than a subset of views of the entire content such that to get a single view, the tile carries the entire lenslet representation.

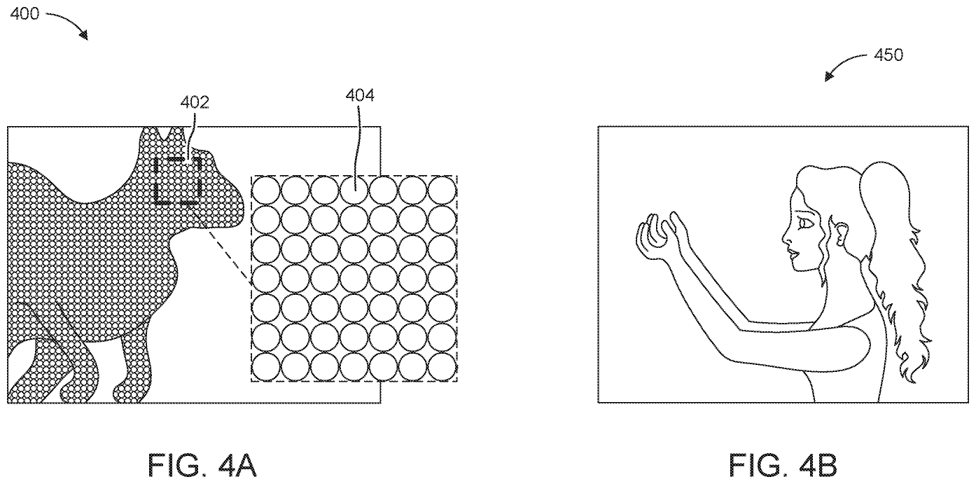

FIGS. 4A-4B are schematic illustrations showing examples of light field data in lenslet format according to some embodiments. Light fields captured with array of cameras produce light field data in multi-view format, such as arrays of full images of the scene taken with varying viewpoints. See the example in FIG. 2. In addition to the camera array producing high resolution sub-views, one alternative approach in representing light field data, instead of arrays of full views, e.g., is to produce a much larger number of sub-views that each feature only a small image area but with a higher angular resolution. Some examples of such lenslet light field images 400, 450 may be seen in FIGS. 4A-4B. FIG. 4A shows a light field region 402 with a set of sub-views 404. Typically, these lenslet types of light fields are produced using microlens array optics in the capturing device. Similar lens arrays may be used in light field display devices to spread the light field data to angular domains, thus recreating approximation of the original light field. These types of light field displays use lenslet light field images corresponding with the display lens array geometry. Lenslet light field format interleaves samples for individual views under each lenslet. For example, Ostendo has been developing a light field display supporting 50×50=2500 samples under each mircolens. See, e.g., Zahir Alipasian & Hussein El-Ghoroury, Small Form Factor Full Parallax Tiled Light Field Display, PROCEEDINGS OF SPIE (17 Mar. 2015). The term plenoptic is also used in describing this format rather than the term lenslet.

Delivering data for such massive number of views without significant data optimization may in some cases be impractical. Lenslet light field data may be optimized by converting the contents of the lenslet light field to a multi-view light field before the compression (cf. Ebrahimi) and back to the lenslet format in the receiver if needed. This optimization was developed for multi-view video and image array light fields. However, the amount of processing and memory bandwidth for such conversion may make such an optimization impractical.

There are some articles describing dedicated optimization developed for lenslet light fields. Many of these articles introduce separate compression steps, considering that there is similarity between lenslet images and frame to frame spatio-temporal compression as understood by Viola, Irene, et al., Objective and Subjective Evaluation of Light Field Image Compression Algorithms, 32ND PICTURE CODING SYMPOSIUM (2016). However, many of these articles are not understood to consider the redundancy in light field data if only one or a few viewpoints are used by the display device or if the view fidelity may be adjusted according to the fovea. For some embodiments, the fidelity of visual elements may be adjusted if the visual objects are within the fovea and/or peripheral vision of the viewer.

Many methods for compressing light field data may be non-optimal depending on the application, especially in cases when, e.g., client viewpoint may be used to guide the rendering and optimization process. For optimizing the rendering and data distribution, only a minimal subset of the full light field data may be produced and transmitted, relying on the viewing client to be able to estimate the data to be used. For lenslet light fields, light field data may be split into separate streams in a manner which enables non-uniform light field fidelity across the light field area.

Light fields produce vast amounts of data and optimizing the data production, storage, and transmission may be helpful. Lenslet format of light fields include a large number of partial views sampled with high angular resolution. Partial views are collected as an array, the format of which may be determined by the microlens array used for capturing the data or the lenslet optics used by the light field display. Each single partial view in the lenslet light field may correspond with a single lens of the lens array. Because the lenslet light field format differs from an image array type of light field, lenslet light fields may use dedicated methods for optimizing the rendering and transmission.

For some embodiments, lenslet light field data transmission is optimized by dividing the lenslet light field data into several sub-streams. Division to sub-streams enables an adaptive streaming system implementation that reduces the amount of light field data transmitted for content delivery.

For some embodiments, a content server may divide lenslet light field data into several sub-streams, optimizing the amount of light field data used by the client to synthesize a view or to display a light field on a light field display with specific display capabilities. On the server side, lenslet light field data may be optimized by estimating the number of full lenslet views used to reproduce the full light field in high quality. The optimized lenslet data may be split into several sub-streams, thus enabling viewing client to selectively control the quality of the light field across the full light field area while also adapting the amount of data transmitted to the available transmission bandwidth and client-side processing resources.

In the primary embodiment, the viewing client is a display device with alens array producing images with high angular resolution. This type of display may be a large-scale stationary light field display or a single user light field HMD, such as understood to be disclosed by Lanman, Douglas and Luebke, David, Near-Eye Light Field Displays, 32.6 ACM TRANSACTIONS ON GRAPHICS (TOG) 220 (2013). Both types of devices may use user and/or eye tracking in order to adjust display fidelity to match viewer's visual perception characteristics.

Some embodiments operate with a client-pull model, similar to the MPEG-DASH, in which the server provides a manifest file to the client indicating data streams available. The client executes a performance analysis to determine bandwidth and processing limitations and adapts data transmission accordingly. While adapting the data transmission, the client may prioritize the streams to be pulled and maximize the perceived quality of experience (QoE) based on the tracking of the users and content analysis.

Transmitting the full lenslet light field with full angular information for each lenslet may use extensive transmission bandwidth. Much of this data may be redundant and may be reproduced by the receiving client from more sparsely sampled data.

Furthermore, a viewing client may adjust quality of the light field rendering to be non-uniform across full light field without reducing the QoE if quality is dynamically adjusted according to the content features and perception characteristics of the viewer.

Some embodiments enable a client to pull just the part of the lenslet light field data to be used at a particular moment, reducing the amount of transmitted data. Furthermore, because the content server divides the lenslet light field data into multiple sub-streams, the data is already optimized by reducing the number of lenslet views with full angular data used to reproduce the full light field.

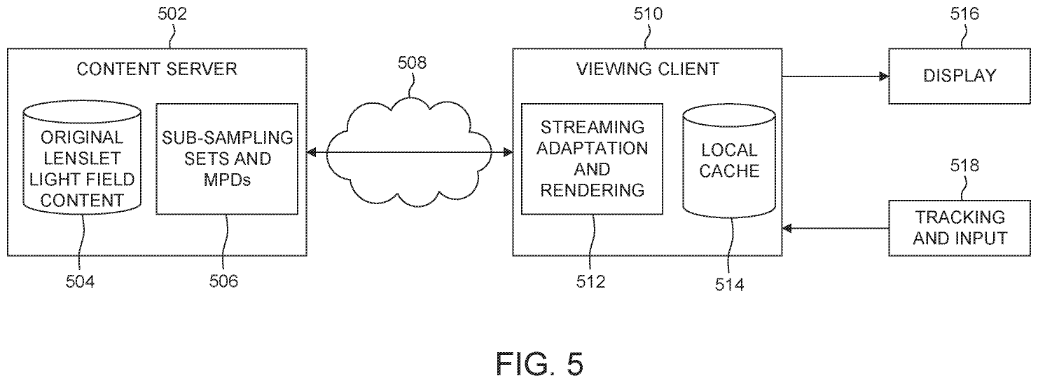

FIG. 5 is a system diagram illustrating an example set of interfaces for a viewing client according to some embodiments. For some embodiments, a viewing client 510 may interface with a display 516 and one or more sensors. A viewing client 510 may include local cache memory 514. One or more displays 516 and one or more sensors may be located locally for some embodiments. For other embodiments, one or more displays 516 and one or more sensors (such as tracking and input sensors 518) may be located externally. For some embodiments, a viewing client 510 may store content locally in a local cache 514. A viewing client 510 may execute a streaming adaptation and rendering process 512 in some embodiments. A viewing client 510 may interface via a network 508, e.g., a cloud network, to a content server 502. For some embodiments, media presentation description (MPD) files and sub-sampling sets of spatial data (such as various resolution and bitrate versions of spatial data) 506 may be stored on the content server 502. For some embodiments, a content sever 502 may store original lenslet light field content 504 in a database.

For some embodiments, the content server 502 may produce multiple sub-sampling sets from the original light field content in lenslet format 504. In addition to the sub-sampling sets, the content server 502 may produce metadata describing properties of the original light field data as well as the available sub-sample sets. The metadata may be stored in a description file called Media Presentation Description (MPD) for the MPEG-Dash protocol.

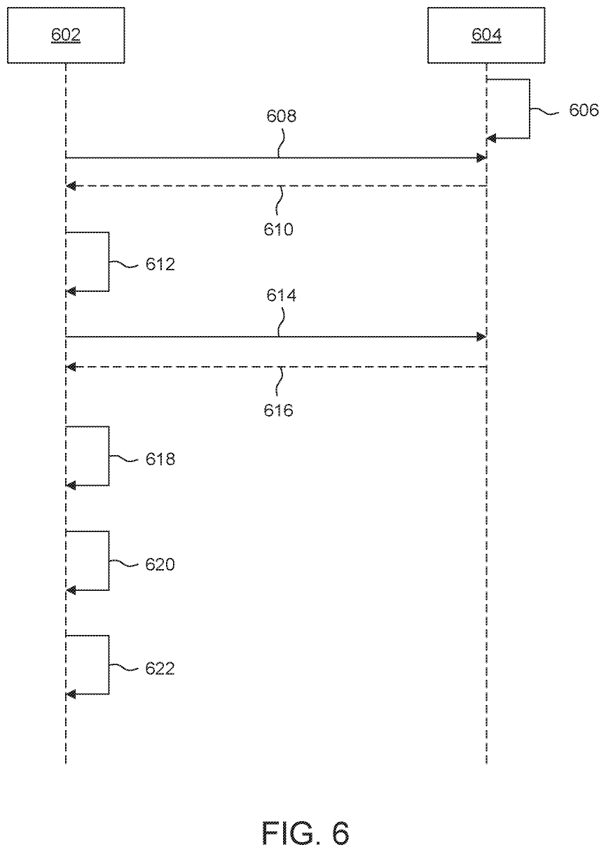

FIG. 6 is a message sequencing diagram illustrating an example process for a typical session sequence according to some embodiments. FIG. 6 illustrates the sequence of communication between a viewer client 602 and a content server 604 in a typical use session. For some embodiments, a content server 604 may render 606 lenslet light field sub-sampling sets and mapping metadata and may generate 610 an MPD. A viewing client 602 may send 608 a content request to the content server 604, and the content server 604 may send back 610 the MPD file. For some embodiments, the content server 604 may divide the light field content into one or more light field regions. The viewing client 602 may select 612 sub-sampling sets for each light field region. The viewing client 602 may request 614 sub-sampling sets from the content server 604, and the content server 604 may send 616 a sub-sampling set of a video sequence re-packed as smaller dense light field and mapping metadata. The viewing client 602 may update 618 the user viewpoint and reproduce a full lenslet light field from the received data, taking into account temporal variability of the light field data. The viewing client may build 620 a motion model of viewpoint motion and predict a viewpoint position for a next time step. The viewing client may analyze 622 content based on predicted view position and performance metrics and may adjust sub-sampling set requests.

For some embodiments, a content server may send to a viewing client a media manifest file describing a plurality of sub-sampled lenslet representations of portions of light field video content. For some embodiments, the content server may receive from the viewing client information indicating a sub-sampled lenslet representation selected from the plurality of sub-sampled lenslet representations. For some embodiments, the content server may send to the viewing client the selected sub-sampled lenslet representation

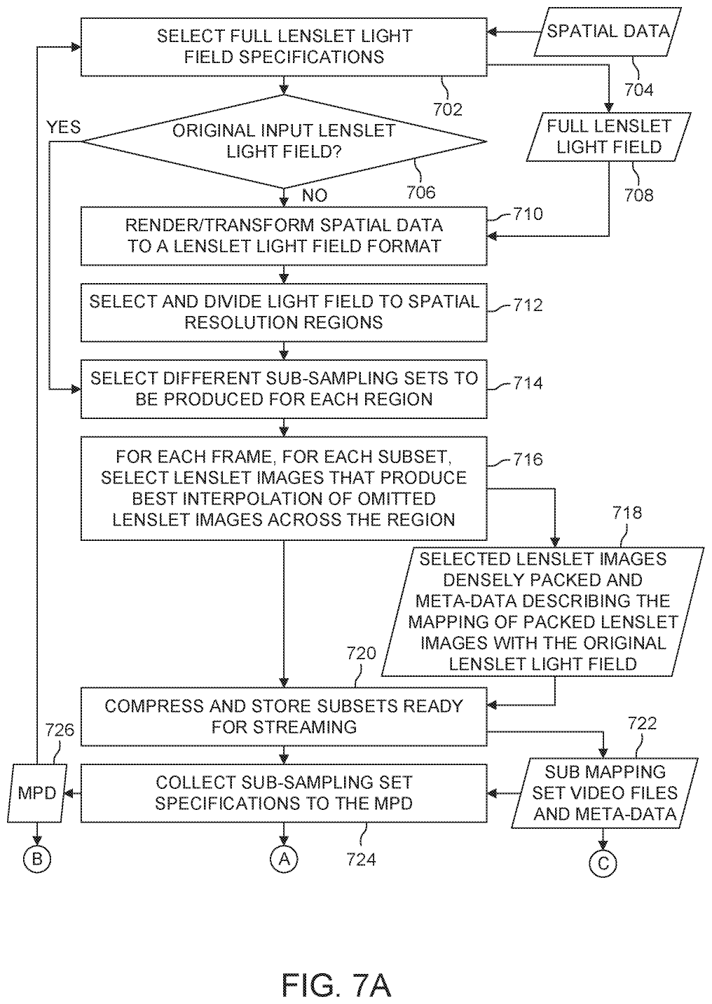

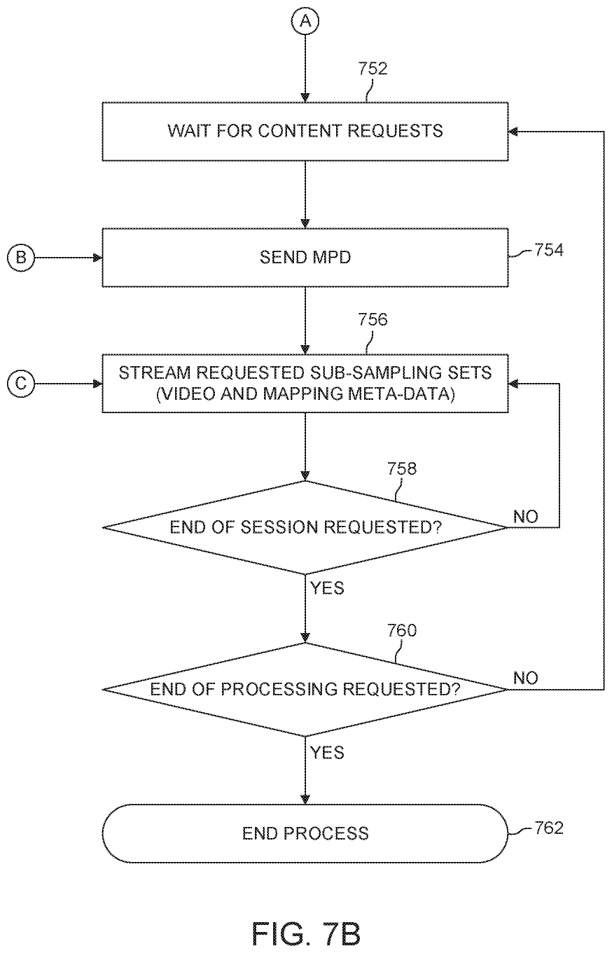

FIGS. 7A-7B are a flowchart illustrating an example process for a content server process according to some embodiments. In lenslet light field format, views with angular variation are interleaved for each lenslet. The interleaved nature of angular resolution makes adaptation across angular resolution difficult with the lenslet format. However, spatial resolution may be adjusted because of the direct relationship between lenslet density and spatial resolution. For some embodiments, the content server divides the full lenslet light field into smaller sub-regions and sub-samples the lenslet data of each sub-region with sampling rates to produce multiple sub-sample subsets that the client requesting the data may select in order to adapt the data stream to the per client constraints and requirements.

Example pre-processing of lenslet light field video and rendering to enable adaptive streaming are described further herein. Also, example structure and data contained in the MPD used to communicate light field specifications and available subsets from server to the connecting client are described further herein. Besides light field data processing and dedicated metadata format, the content server may operate, e.g., similar to a video content server delivering data to a client using MPEG-DASH type of adaptive content distribution. FIGS. 7A-7B illustrate example processing executed by the content server.

The server process may perform content pre-processing in which the server produces multiple light field data subsets and metadata describing the subsets. First step in the process is the selection 702 of the full lenslet light field specifications. The server may produce light field data to be streamed, e.g., from an existing lenslet light field 708, from an image array light field, or from spatial data 704 in full 3D format, such as a real-time 3D scene or point cloud. The server may determine 706 if an original input lenslet light field s to be used. For image array light fields and full 3D scenes, the server renders and/or transforms 710 the data into a lenslet format. For rendering and/or transforming 710 the data, the server uses specific lenslet light field specifications which may be selected 712 and/or set on the first time step and may be saved to the MPD. For existing lenslet light fields, the specifications may be collected and saved to the MPD. The regional division of the full lenslet light field may be determined 712. The sampling to be used within regions may be determined 714, and sub-sampling sets with selected samplings may be produced 716. This example process of subsampling set production is described further in more detail herein.

Sub-sampling sets 718 that are produced may be compressed and stored 720, ready for streaming. Sub-sampling sets of video files and meta-data 722 may be compressed for a streaming video format with a suitable, existing encoder and various versions may be produced using varying compressions and resolutions. Information about sub-sampling set versions produced are collected in the MPD.

If the server has produced sub-sampling sets that may be streamed to the viewing client, and if the server has compiled (or collected 724) information about the lenslet light field specifications and available sub-sampling sets to the MPD 726, the server may be ready to stream content to the clients in response to client requests. The server may switch to the run-time mode (mostly FIG. 7B) and wait 752 for client requests. If a client connects and requests content, the MPD is transmitted 754 to the client. The client may choose, based on the MPD, which parts of the content to request for streaming. For some embodiments, streaming 756 may continue until an end of session 758 is requested. For some embodiments, the run-time process continues until an end of processing 760 is requested, at which point the process may end 762.

For some embodiments, a content server process may include: sub-sampling a full lenslet data set to number of sparsely sampled regions; producing Media Presentation Description (MPD) specifying original lenslet data properties and available sub-sample sets, waiting for content requests, sending an MPD to the client requesting content, and streaming requested sub-sample sets to the client.

For some embodiments, a sub-sampling rate may be selected for a lenslet representation. For some embodiments, a light field spatial resolution may be selected, and the light field content may be divided to correspond to the selected light field spatial resolution.

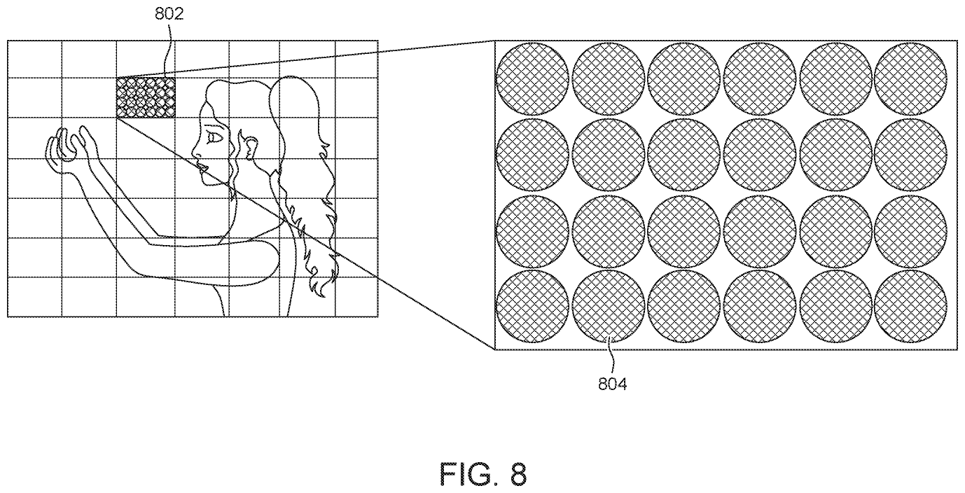

FIG. 8 is a schematic illustration showing an example full lenslet light field divided into regions according to some embodiments. For some embodiments, lightfield data is pre-processed before the content server distributes the light field data in an adaptive lenslet format. In the pre-processing, the lenslet light field may be divided into regions, and sub-sampling sets may be produced for each region. For each region, there may be multiple versions of the light field data available such that the client may request light field data for various parts of the light field at non-uniform fidelity.

FIG. 8 illustrates a full lenslet light field frame divided into several regions. For example, division into regions may be made so that a pre-defined number of individual lenslet sub-views in a single region, or the division may be made so that there are a pre-defined number of regions. For some embodiments, the division may be done using non-uniform region sizes or region sizes or areas may be assigned dynamically and may be assigned based on, for example, content analysis. For the example shown in FIG. 8, the full lenslet light field frame is divided into a 7×7 array of regions 802, and within each region, there is a 6×4 array of lenslet sub-views 804.

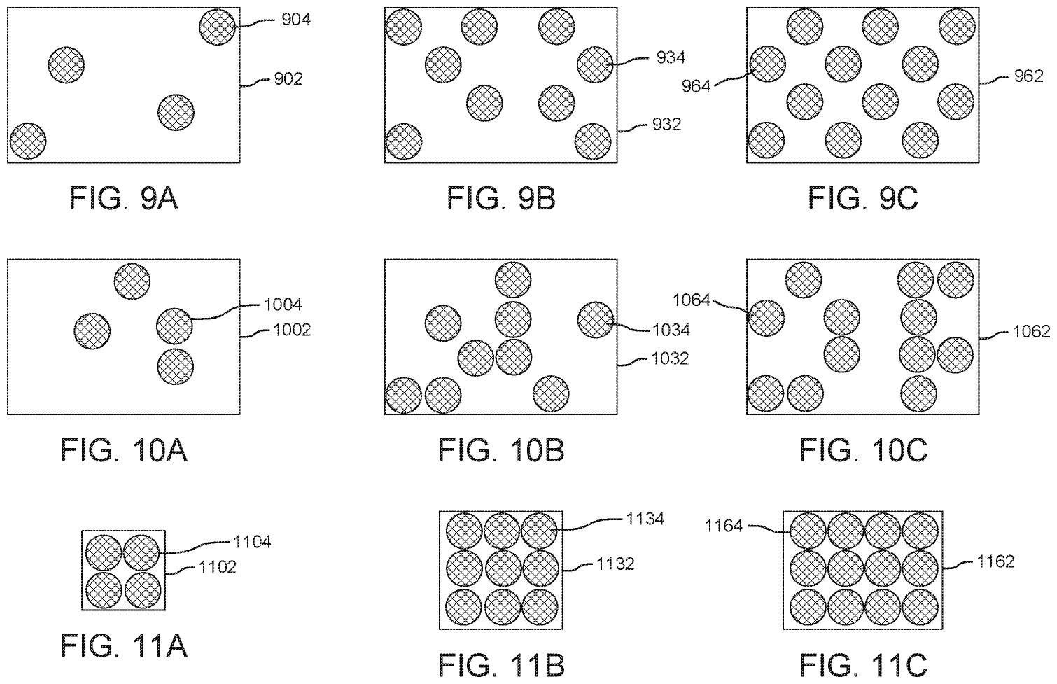

FIGS. 9A-9C are schematic illustrations showing example sub-sampling sets with varying sub-sampling densities at a first time step according to some embodiments. FIGS. 10A-10C are schematic illustrations showing example sub-sampling sets with varying sub-sampling densities at a second time step according to some embodiments.

If the content has been divided into regions, the content server may produce sub-sampling sets for the regions. The content server may produce several versions of the light field content with varying sub-sampling densities of the light field data for each region. Sub-sampling sets may be produced by reducing the number of individual lenslet sub-views included with the data, thereby omitting one or more of the sub-views from the full light field data. For a given sub-sampling density, the number of lenslet sub-views to be stored is fixed. The locations of the actual lenslets may change (or have temporal variance) or may be fixed throughout the lenslet light field video. Selection of lenslet locations to be included with a sub-sampling set may be based on sub-view analysis that estimates which sub-views may be used for the most accurate interpolation of the omitted sub-views. This analysis may be done frame by frame, which may cause dynamic variation of the sub-view locations used in the sub-sampling set.

FIGS. 9A-9C and 10A-10C illustrate lenslet sub-view locations selected to be included with sub-sampling sets with three different sampling densities and positions at two different time steps. FIGS. 9A and 10A show examples of sub-sampling sets 902, 904 with a ⅙ sub-sampling density of sub-views 904, 1004 at first and second time steps, respectively. FIGS. 9B and 10B show examples of sub-sampling sets 932, 1032 with a ⅜ sub-sampling density of sub-views 934, 1034 at first and second time steps, respectively. FIGS. 9C and 10C show examples of sub-sampling sets with a ½ sub-sampling density of sub-views 964, 1064 at first and second time steps, respectively.

FIGS. 11A-11C are schematic illustrations showing example sub-views selected for sub-sampling sets packed as dense integral images according to some embodiments. FIG. 11A shows an example of a sub-sampling set 1102 with a ⅙ sub-sampling density of sub-views 1104 packed as dense integral images. FIG. 11B shows an example of a sub-sampling set 1132 with a ⅜ sub-sampling density of sub-views 1134 packed as dense integral images. FIG. 11C shows an example of a sub-sampling set 1162 of sub-views 1164 with a ½ sub-sampling density packed as dense integral images.

Sub-views selected for sub-sampling sets may be re-arranged into a dense array, forming dense integral images but with a reduced number of sub-views. For each sub-sampling set, the individual frames formed by the packed sub-views may be compiled into a video file together with a metadata file indicating the mapping of the packed integral image lenslet location to the original lenslet sub-view location in the original lenslet light field integral image. Mapping metadata may be compiled into MPD as part of each representation block indicating the mapping of sub-sampling sets. Also, the metadata header may indicate the lenslet size for a particular resolution of the available sub-sampling set. Listing 1 shows example metadata that map a packed sub-sampling 2×2 array (FIG. 11A) to the original images (FIGS. 9A and 10A) according to some embodiments. For this example, the locations are given with an x-y coordinate system (x, y) with an origin in the upper right corner.

Listing 1. Mapping Metadata

```
Resolution 1
  Individual sample size in pixels: n1 x m1 pixels
Resolution 2
  Individual sample size in pixels: n2 x m2 pixels
Time step 1
  Packed location 1, 1 Original location 1, 1
  Packed location 2, 1 Original location 5, 2
  Packed location 1, 2 Original location 2, 3
  Packed location 2, 2 Original location 6, 4
Time step 2
  Packed location 1, 1 Original location 4, 1
  Packed location 2, 1 Original location 3, 2
  Packed location 1, 2 Original location 5, 2
  Packed location 2, 2 Original location 5, 3
```

Some embodiments may use subsampling patterns to streamline the description of the sample positions. For example, instead of indicating a mapping of individual lenslet samples from a packed format to the original full lenslet array, the mapping metadata may indicate time steps and the sub-sampling pattern. Regular sub-sampling patterns may be identified in the header of the mapping metadata along with individual sample pixel size configurations.

Video files compiled from sub-sampling sets may be encoded and compressed using other video formats and codecs. For some embodiments, several versions of the sub-sampling set video files with different resolutions may be produced. Reducing resolution of the lenslet integral image effectively reduces both angular and spatial resolution of the light field that may be reconstructed from the data.

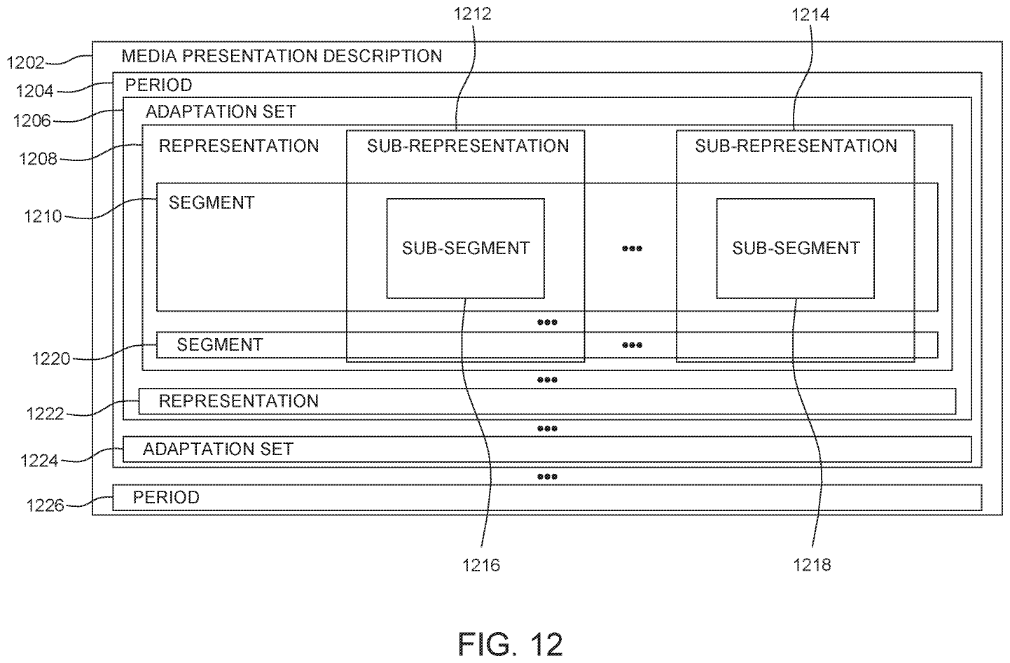

FIG. 12 is a data structure diagram illustrating an example MPEG-DASH Media Presentation Description (MPD) according to some embodiments. A client-pull model may use the general structure of the MPEG-Dash media presentation description (MPD) illustrated in FIG. 12, because the file format used for transmitting the overall media description may be downloaded by the viewing client to initialize the streaming session.

FIG. 12 is a data structure diagram illustrating an example MPEG-DASH Media Presentation Description (MPD) according to some embodiments. FIG. 12 shows a structure of an MPEG-DASH media presentation description (MPD) file. This file format may be used for the MPD transmitted by the content server to the viewing client. For some embodiments, the MPD file may be sent to start initialization of a streaming session. The MPD file 1202 may include one or more periods 1204, 1226 as the top hierarchical entity. The period 1204, 1226 may include a start time and duration for content. Each period provides the information of a single lenslet light field scene, for example a light field using fixed camera location and/or lightfield specification. An entire user experience may include several scenes with each scene corresponding to a period block.

The period 1204, 1226 may include one or more adaptation sets 1206, 1224. The first adaptation set 1206 may list each available lenslet light field sub-sampling set for each region of the light field. After the first adaptation set 1206 that describes the overall structure of sub-sampling sets created for each region, the second and subsequent adaptation sets 1224 may indicate details about the sub-sampling sets for each region.

Many of the adaptation sets 1206, 1224 may contain a media stream. The adaptation set 1206, 1224 may include one or more representations 1208, 1222. Representations 1208, 1222 may include one or more encodings of content, such as 720p and 1080p encodings. Representations 1208, 1222 may include one or more segments 1210, 1220. The segment 1210, 1220 is media content data that may be used by a media player (or viewing client) to display the content. The segment 1210, 1220 may include one or more sub-segments 1216, 1218 that represent sub-representations 1212, 1214 with a representation field. Sub-representations may contain information that apply to a particular media stream.

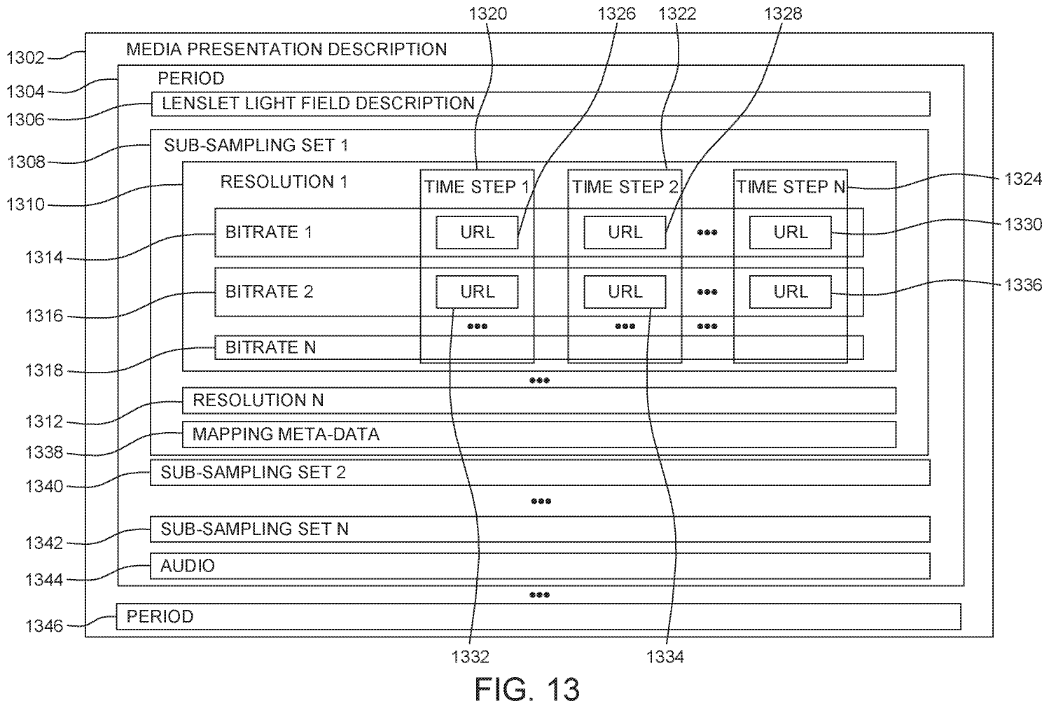

FIG. 13 is a data structure diagram illustrating an example Media Presentation Description (MPD) with example lenslet light field description(s), sub-sampling sets, resolutions, and bitrates according to some embodiments. FIG. 13 illustrates how the MPD 1302 data may be organized within the MPEG-DASH general MPD structure.

The next level of hierarchy after the period 1304, 1346 is the lenslet light field specification 1306. The light field specification 1306 may indicate division of the full lenslet light field into regions, individual lenslet images in each region, spatial and angular resolution of lenslets, location and measurements of the lenslet light field capturing and/or rendering setup, and an overview of the scene layout, size and placement of the scene elements.

Each sub-sampling set 1308, 1340, 1342 may have metadata 1338 describing the mapping between densely packed sub-sampled lenslet image locations in the video files and lenslet locations in the original full lenslet light field. In each sub-sampling set 1308, 1340, 1342, versions of the same data encoded in different ways may be provided. Each version may be in a different resolution 1310, 1312, and different resolution versions 1310, 1312 may provide the same resolution content using compression with varying bitrates 1314, 1316, 1318 or varying supported codecs.

Each encoding version, called a bitrate 1314, 1316, 1318 in FIG. 13, provides links to the video files in which sub-sampled lenslet images may be re-packed as a dense lenslet light field. Each video file may be divided temporally into sub-segments, enabling a client to switch between different versions within a single period. Sub-segment blocks of the MPD may provide a URL link 1326, 1328, 1330, 1332, 1334, 1336 to the actual video data. The URLs may be associated with a time step 1320, 1322, 1324. Some periods 1304, 1346 may include audio data 1344.

Relating FIGS. 12 and 13 together, sub-sampling sets may correspond to MPEG-DASH adaptation sets, and resolutions under a given sub-sampling set may correspond to MPEG-DASH representations and segments. For some embodiments, media blocks may correspond to MPEG-DASH representations, and time steps may correspond to sub-representations.

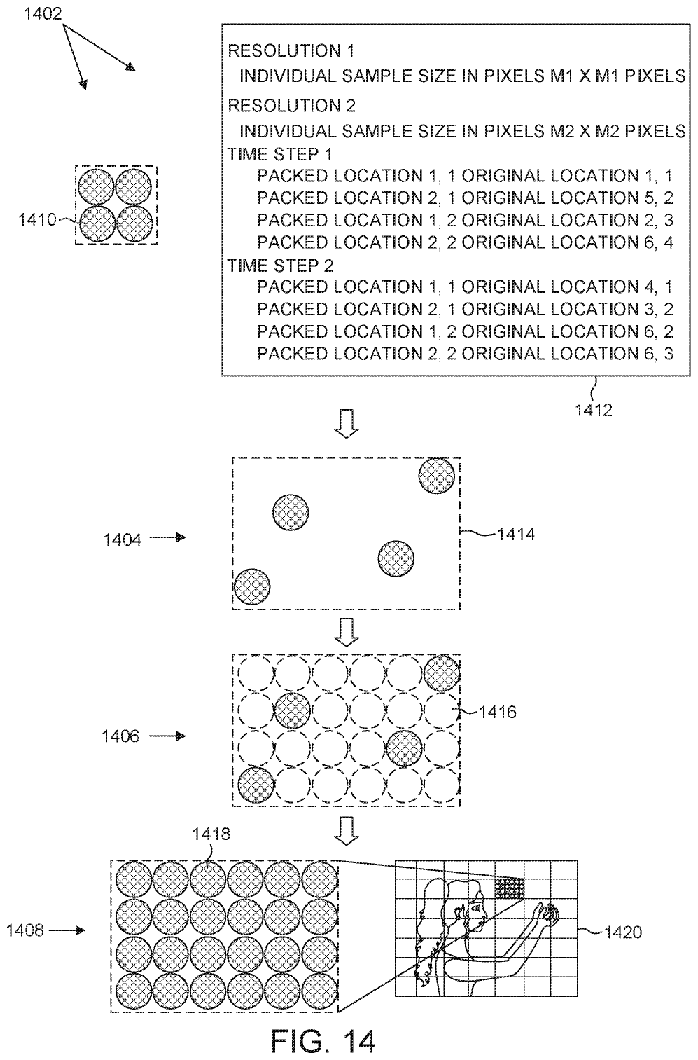

FIG. 14 is a process diagram illustrating an example lenslet array reconstruction process according to some embodiments. FIG. 14 illustrates an example process executed by a client such as a viewing client. For some embodiments, the user launches an application implementing the viewing client, and a process is executed by the viewing client. If a user starts the application, the user may indicate the content to be viewed. For some embodiments, content may be communicated as a link to content residing on the content server. The link to the content may be a URL identifying the content server and a specific MPD file. A viewing client application may be launched by, e.g., an explicit command of the user or automatically by the operating system based on an identifying content type request and application associated with the specific content type. For some embodiments, the application is a stand-alone application. For some embodiments, a viewing client may be integrated with a web browser or social media client. For some embodiments, the application may be part of the operating system.

If a viewing client application is launched, the application may initialize sensors (e.g., geo-position, and imaging sensors) used for tracking the device, the user, and/or the user's gaze direction. Based on the display specifications, tracking settings, and application-specific settings, the viewing client may determine initial sub-sampling sets to be requested from the server. For some embodiments, tracking a device, such as an HMD, a user (such as with use of a stand-alone display), and/or a user's eyes may be used to determine gaze direction of the user. For some embodiments, gaze direction may be used to determine which content areas are seen by the user's fovea and which content areas are seen in the user's peripheral vision. Such determinations may be used to control the level of fidelity and the adaptation of streaming, for some embodiments.

If the selected sub-sampling sets have been requested, the client may download associated video and metadata and download sub-segments sequentially from the server. If the first sub-segments have been received, the client may begin run-time operation. In run-time, the client may update the viewpoint based on the tracking and user input (e.g., the user adjusting the viewpoint with user interface controls). Using the updated viewpoint, the client may render the light field from the received data as the display-specific format.

For some embodiments, an example rendering process is illustrated in FIG. 14 for an example 2×2 array sub-sampling set 1410. The client may receive 1402 the sub-sampling set 1410 and set-specific mapping meta-data 1412. The client may, in some embodiments, use the sub-sampling set specific mapping metadata 1412 to map 1404, 1406 lenslet images from the received sub-sampling sub-segment to the lenslet locations of the full lenslet light field 1414. For some embodiments, the missing lenslet images 1416 from the received sub-sampling set may be reconstructed by interpolating 1408 between received lenslet images to produce, e.g., a full lenslet light field of lenslet images 1418 as shown the example process of FIG. 14. In some embodiments, the full lenslet 1420 produced in the rendering may have, e.g., different specifications from the original lenslet light field the server originally used for creating the sub-sampling sets. For example, the viewing client may produce a lenslet light field corresponding with the display device specifications in the rendering process.

For some embodiments, a client may receive a packed sub-sampling set and mapping metadata. Individual lenslet samples may be transformed from packed locations to the original lenslet locations in the original lenslet array according to correct time step mappings indicated in the metadata. For some embodiments, lenslet samples omitted from the sub-sampling set may be reconstructed by interpolating from the transmitted samples. For some embodiments, the full lenslet light frame may be created by repeating this process for each light field region in the frame. In some embodiments, the full reconstructed lenslet light frame may be displayed by the viewing client.

For some embodiments, interpolating views from a retrieved sub-sampled lenslet representation using the description of the lenslet representation in the manifest file may include: unpacking the retrieved sub-sampled lenslet representation into original lenslet locations of the portion of light field video content indicated in the manifest file; and interpolating lenslet samples omitted from the retrieved sub-sampled lenslet representation. For some embodiments, interpolating views from a retrieved sub-sampled lenslet representation generates a complete light field region image for a portion of the light field video content.

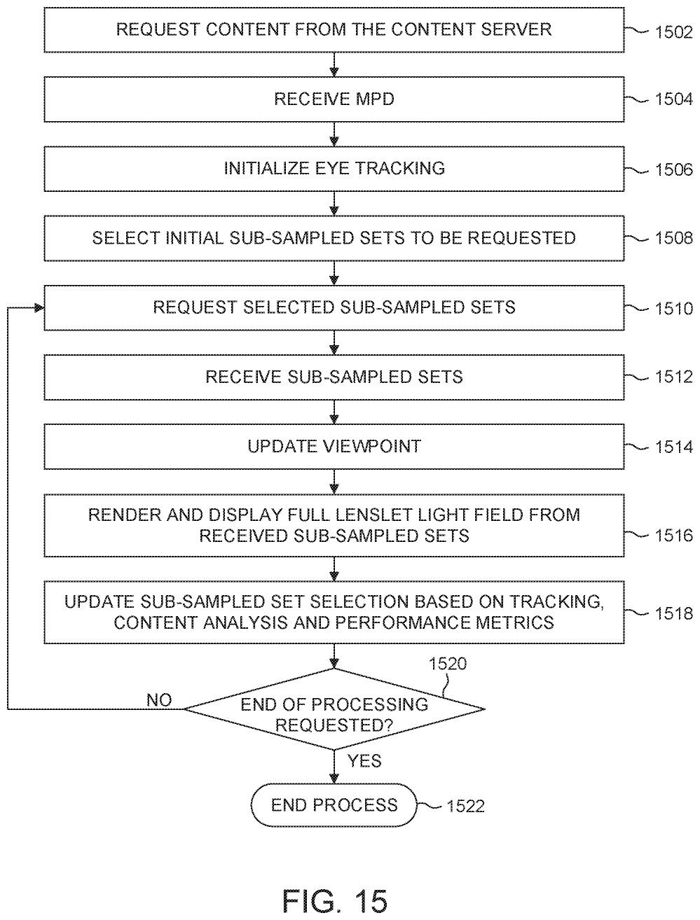

FIG. 15 is a flowchart illustrating an example process for a viewing client according to some embodiments. During the run-time process, the client may adapt the selection of sub-sampling sets. According to the example, the client may decide light field region by region which and how many sub-sampling sets to pull and with what resolution and compression quality. For some embodiments, different compression qualities and different compression techniques may be used for each region. For some embodiments, the selection may be done according to the viewpoint motion, content complexity, display capabilities, current network and processing performance or any other local criteria.

For some embodiments, an example viewing client process may include requesting 1502 content from the content server. The viewing client may receive 1504 the MPD in response. The viewing client may initialize 1506 tracking (which may include, e.g., eye tracking, gaze tracking, user tracking, and/or device tracking). An initial viewpoint may be set for some embodiments. The viewing client may select 1508 the initial sub-sampled sets to be requested and request 1510 those selected sub-sampled sets from the content server. The requested sub-sampled sets and mapping metadata may be received 1512 by the viewing client from the content server. The viewpoint may be updated 1514. The viewing client may unpack the received lenslet sub-sampled sets from packet transmission format into full lenslet images using the mapping metadata indicating the original locations in the full lenslet image (or frame or region for some embodiments). Missing lenslet samples may be interpolated, and the fidelity may be adapted based on the current viewpoint. For some embodiments, the resolution of the viewing area may be adjusted if interpolating missing lenslet samples. For some embodiments, if the area is not in the fovea area, reconstruction of the original full lenslet light field for the area may be done with a lower spatial resolution. The full lenslet light field image may be rendered and displayed 1516. The sub-sampled set selections may be updated 1518 based on tracking data (which may include eye tracking, gaze tracking, user tracking, and/or device tracking), user input, content analysis, and/or performance metrics. For some embodiments, based on the gaze direction detected by the tracking, regions that are further away from fovea may be set to have a lower sub-sampling rate. For some embodiments, based on the user input or performance metrics, the sub-sampling rate of all of the regions may be adjusted to be lower or higher. If an end of processing is not received 1520, the viewing client process may repeat by requesting the updated selections of sub-sampling sets. Otherwise, the process ends 1522.

For some embodiments, a viewing client may update a viewpoint of a user; and may adjust the selected lenslet representation for the updated viewpoint. For some embodiments, a viewing client may predict a viewpoint change of the user; and may adjust the selected lenslet representation for the predicted viewpoint. For some embodiments, a viewing client may select a sub-sampling rate for the selected lenslet representation, such that the sub-sampling rate uses the predicted viewpoint. For example, if a user viewpoint is changed to a spot to the left of the current viewpoint, regions of the light field image that are closer to the new viewpoint may have the associated sub-sampling rate increased to generate higher quality images in the areas around the new viewpoint. Likewise, regions further away from the new viewpoint may have the associated sub-sampling rate decreased. For some embodiments, the light field spatial resolution may be adjusted to improve a performance metric of the interpolated views. For example, the spatial resolution may be increased for regions and portions of regions closer to the user viewpoint and may be decreased for regions and portions of regions further away from the current viewpoint. These changes may result in a higher user satisfaction, a higher image resolution, and/or a higher lenslet density, for example, in the areas around the current user viewpoint.

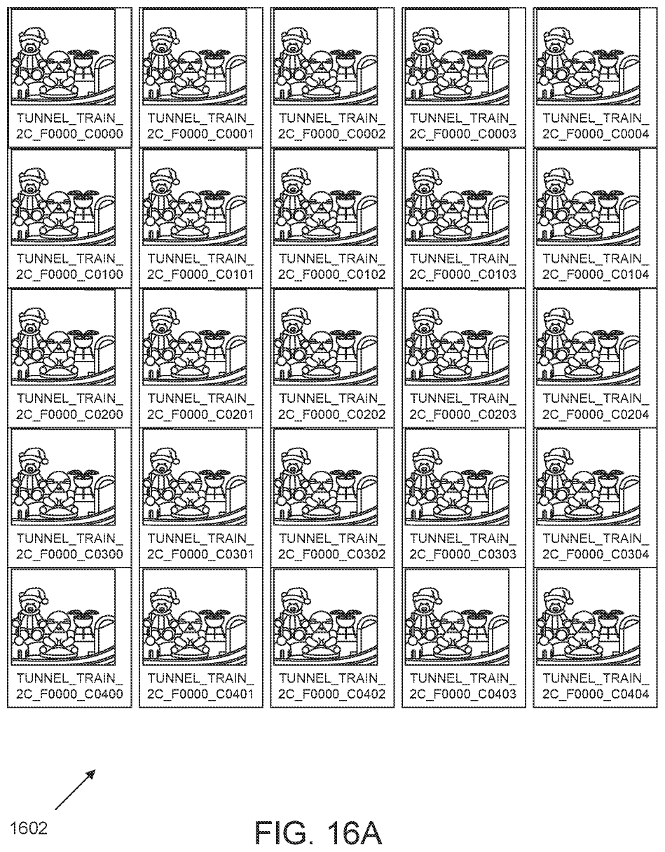

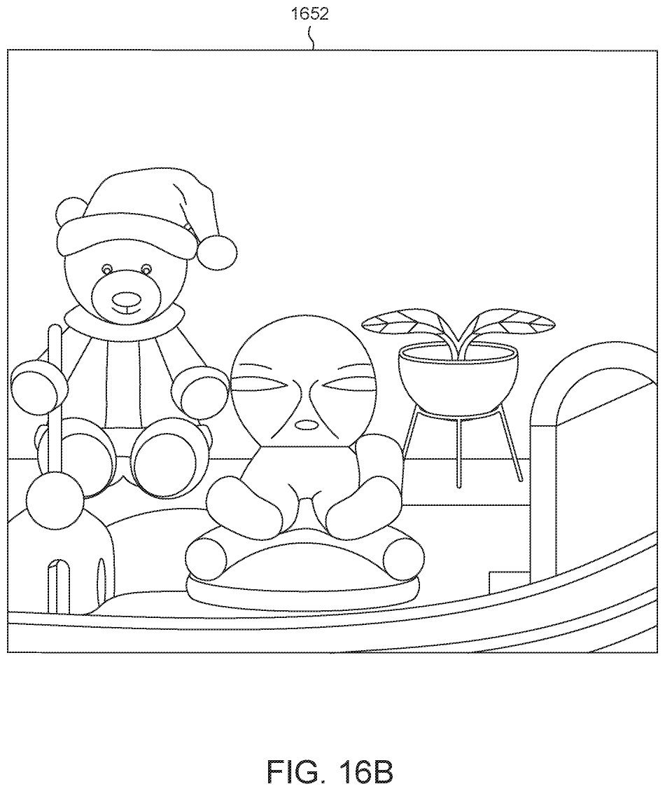

FIG. 16A is a schematic illustration showing an example multi view array representation according to some embodiments. FIG. 16B is a schematic illustration showing an example full lenslet representation according to some embodiments. The test data set m41995 from Ebrahimiis used in FIGS. 16A to 18B. Two equivalent representations of sample content, multi-view (multi-view array representation 1602) and lenslet (full lenslet representation 1652), are shown in FIGS. 16A and 16B, respectively. For FIG. 16B, the views are interleaved per pixel.

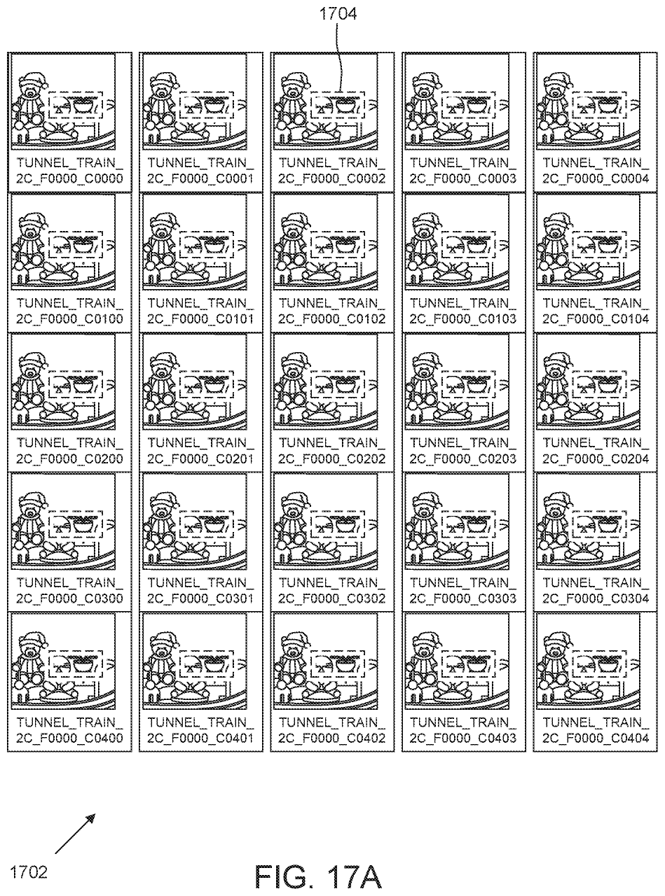

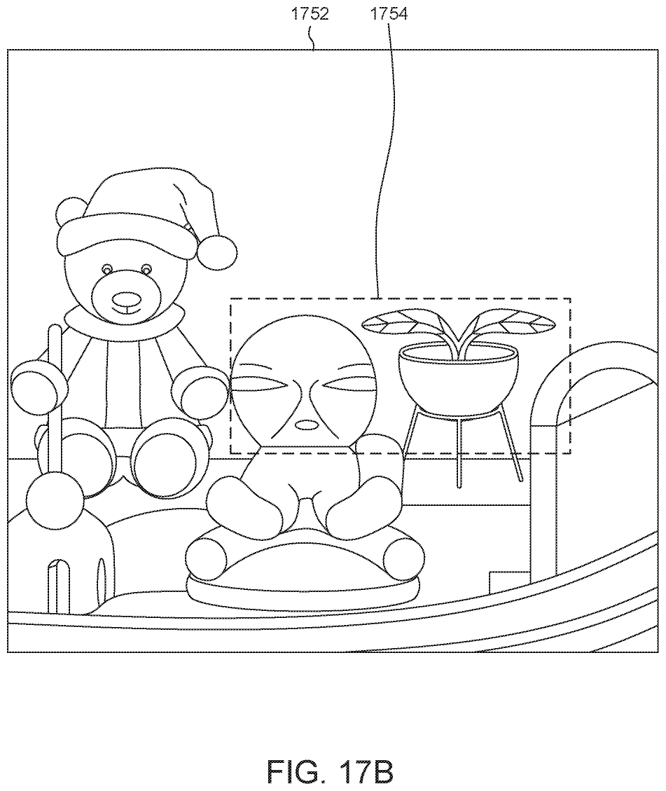

FIG. 17A is a schematic illustration showing an example multi view array representation with ROI illustrated according to some embodiments. FIG. 17B is a schematic illustration showing an example full lenslet representation with ROI illustrated according to some embodiments. The region of interest (ROI) 1704, 1754 is shown as a small dashed rectangle in the center of each representation 1702, 1752. Two equivalent representations of sample content, multi-view and lenslet, are shown in FIGS. 17A and 17B, respectively. If the client wants a limited region of interest (ROI), this limited ROI may be indicated in the MPD.

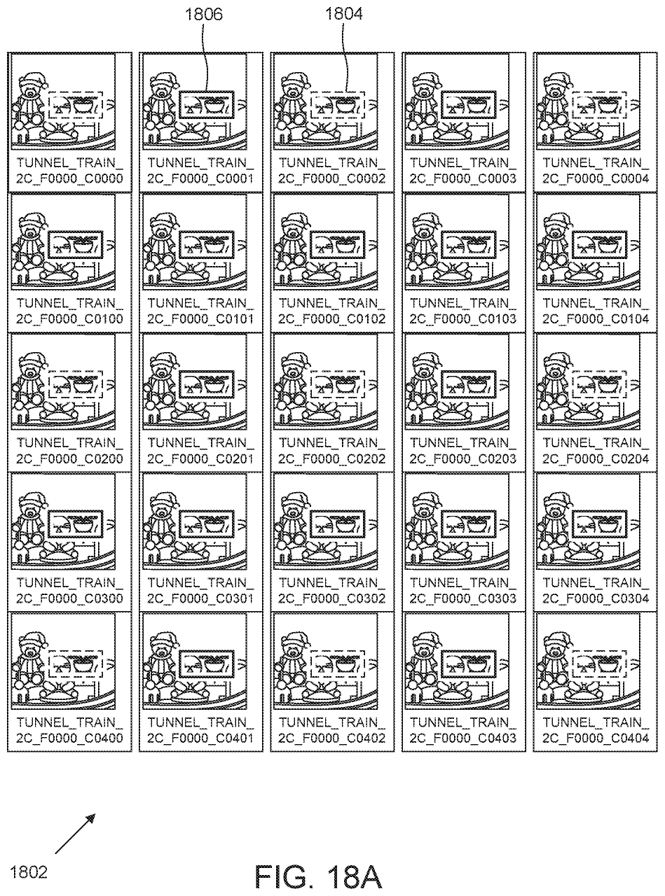

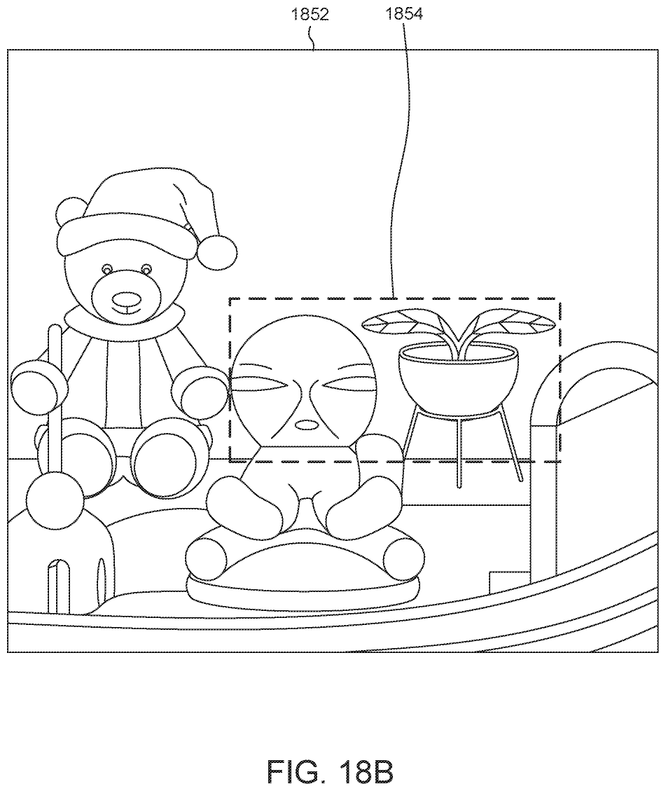

FIG. 18A is a schematic illustration showing an example multi view array representation with ROI illustrated and selected views according to some embodiments. FIG. 18B is a schematic illustration showing an example full lenslet representation with ROI illustrated according to some embodiments. Two equivalent representations of sample content, multi-view 1802 and lenslet 1852, are shown in FIGS. 18A and 18B, respectively. Limited selected views are shown for the multi-view array of FIG. 18A. In FIG. 18A, the selected views are shown as dashed ROI rectangles 1804, and the unselected views are shown with solid ROI rectangles 1806. FIG. 18B shows a selected view with a dashed ROI rectangle 1854. If the client wants a limited number of views (e.g., only dashed ROI rectangles) corresponding to sub-sampling of the lenslet representation, the limited number of views may be indicated in the MPD.

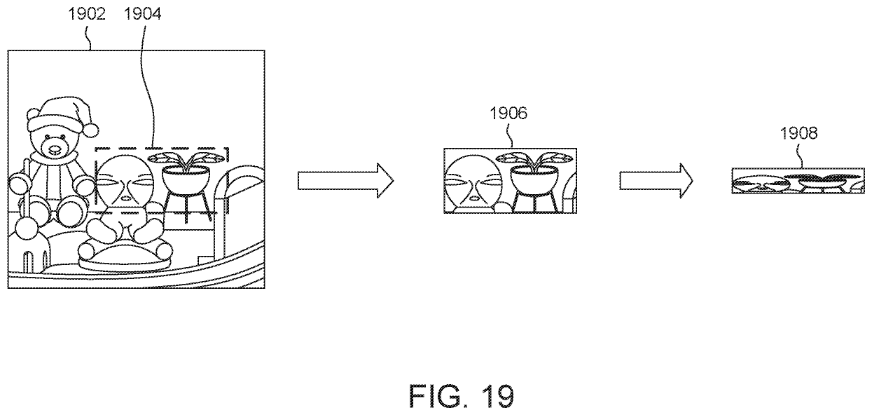

FIG. 19 is a process diagram illustrating an example sub-sampling process for selecting lenslet views according to some embodiments. The indication of a subset of views is shown in FIGS. 18A-18B. The lenslet representation is not shown to avoid confusion regarding the interleaving. The corresponding ROI cropping and subsampling is shown in FIG. 19.

On the left side of FIG. 19, a full image 1902 with 425×425 samples is shown. A region of interest (ROI) 1904 is shown in the center of the full image 1902. The ROI 1904 is extracted from the full image 1902. For this example, the top left corner of the ROI 1904 is at coordinate (200, 200), and the lower right corner of the ROI 1904 is at coordinate (325, 325). The cropped image 1906 has 125×225 samples. The cropped image 1906 is divided into 5 vertical and 5 horizontal regions (25 total regions). The cropped image 1906 is sub-sampled to limit views, and the sub-sampled set 1908 is 25×133 samples with 1 vertical region and 3 horizontal regions (3 total regions).

A sample MPD giving different ROI and lenslet sampling options is shown in Listing 2 according to some embodiments. This listing illustrates three different LF lenslet adaptation sets: Full, Center and Left. The range of lenslet views is expressed for each different set. Note for a given total resolution, fewer views give more pixels per view. Note subranges may overlap giving different representations. Lenslet density is specified in addition to range. Horizontal only specified by [N,1] density. Traditional DASH rate and resolution adaptation may be used within each view category. An example of UHD/HD shown in the “Center” adaptation set. The MPD example shown in Listing 2 corresponds to the sub-sampling process shown in FIG. 19.

Listing 2. Example MPD Listing

```
<MPD LightFieldLensLet =[425x425] lenslet density[5,5]”> >
<AdaptationSet id=“Full“ contentType=“LightFieldLensLet”>
  <!-8Kp Representation at 1000 Mbps and 10 second segments -->
  <Representation id=“UHD2″ bandwidth=“1000000000″ width=“7680″
    height=“4320“>
<AdaptationSet id=“Center“ contentType=“SubLenslets”
  ROI=“[200,100],[325,325], lenslet density [3,3]”>
  <!-4Kp Representation at 100 Mbps and 10 second segments -->
  <Representation id=“UHD″ bandwidth=“100000000″ width=“3840″
    height=“2160“>
  ...
  <!-1080p Representation at 20 Mbps and 10 second segments -->
  <Representation id=“HD″ bandwidth=“20000000″ width=″1920″
    height=″1080”>
  ...
<AdaptationSet id=“Left” contentType=“SubLenslets”
  ROI=“[200,100],[325,325], lenslet density[3,1]”>
  <!-8M point Representation at 100 Mbps and 10 second segments -->
  <Representation id=“UHD″ bandwidth=“100000000“>
  ...
```

The MPD may include details of entire light field lenslet representation (such as N×M view positions). Subsets corresponding to limited horizontal and vertical ranges may be indicated in the MPD. Adaptation sets within MPD may include subsets of lenslet representations with varying angular locations and ranges of lenslet representation

For some embodiments, in the context of adaptive streaming, the content server may prepare versions of the content which are reduced relative to the entire scene. Reductions may include both limited image ROI and limited number of viewing directions. A viewing client may base its selection on a number of factors including, e.g., display capability, viewer gaze, and bandwidth.

The number and specifics of lenslet sub-views may depend upon the desired characteristics of the display. A display achieving simple multi-view representation may choose few sparse lenslet views. A display capable of providing smooth motion parallax, either via native multi-view or viewer tracking, may select a moderate density of lenslet views. A display providing nature focus cues may use a high lenslet density. For another example, if the display provides only views differing in horizontal direction, such as a Looking Glass display available at lookingglassfactory<dot>com, a horizontal parallax-only representation may be selected.

For some embodiments, the ROI may be selected based on current or predicted viewer gaze. This selected ROI may be used with explicit ROI representations for individual streams or may be enabled via tiled-based streaming of a lenslet image. In general, high density lenslet data may be selected centered around the location of viewer gaze while lower density lenslet, or flat 2D data, may be selected farther from the location of viewer gaze.

Adaptive streaming systems may use measures of bandwidth to select among different resolution or bitrate representations of content. For streaming lenslet content, in addition to the display capability described above, bandwidth limits may cause the client to select a lower lenslet density that the client is capable of relying upon view interpolation to generate the intermediate views which are not transmitted. Thus, the lenslet density is an additional factor in adaptation to spatial resolution.

For some embodiments, a viewing client may select a lenslet representation using a capability of a client. For example, a viewing client may select a lenslet representation that has higher resolution images because the viewing client's display is able to handle higher resolution images. Other examples include bitrate, bandwidth available, bandwidth to be consumed, and maximum lenslet density supported by the display of the viewing client. For some embodiments, selecting a sub-sampled lenslet representation may include selecting a sub-sampled lenslet representation with a density above a threshold supported by the client.

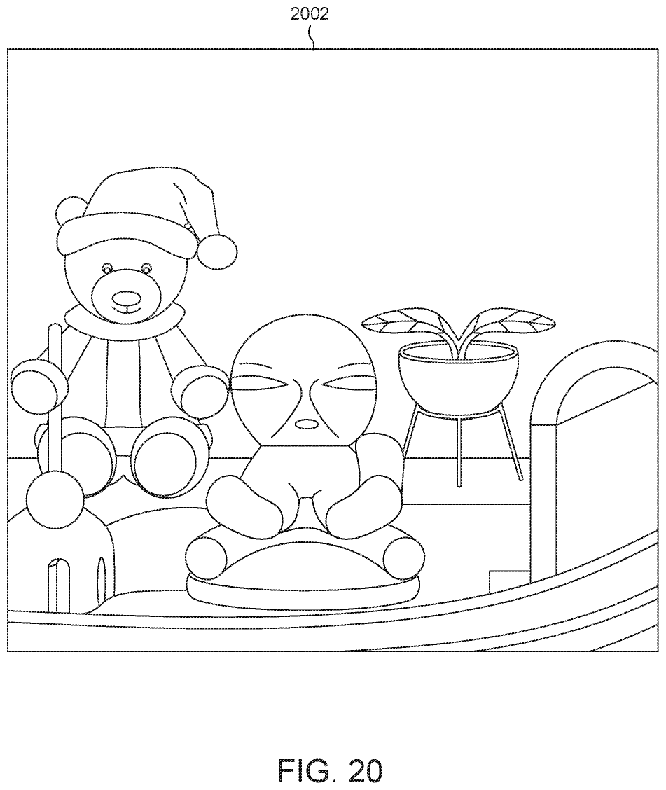

FIG. 20 is an image illustration showing an example full lenslet image with 425×425 samples and 5×5 views according to some embodiments. The example in FIG. 20 is a full lenslet image 2002. As noted above in relation to the use of viewer gaze to specific lenslet streams, tiled-based streaming may be used for some embodiments such that multiple content representations may be produced differing in lenslet density. Each representation is an entire image of the scene but decomposed into tiles for distribution. A client may select tiles around the viewer gaze point to be represented with a high lenslet density and tiles outside the region of viewer gaze point to be represented with a lower lenslet density, such as a flat 2D representation. For some embodiments, the streams may not use an ROI declaration, relying on tiling to address limited ROI, but for streams with different lenslet densities, an ROI may be provided. Full sub-sampled lenslet images, which may serve as the source for adaptive streaming, are shown in FIGS. 20-23. FIG. 20 shows an example full lenslet image with 425×425 samples and 5×5 views.

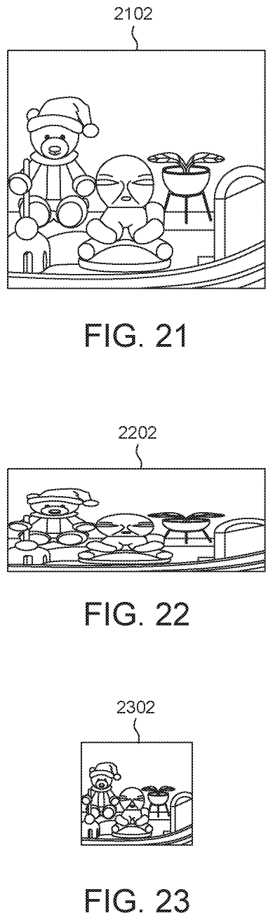

FIG. 21 is an image illustration showing an example sub-sampled lenslet image with 255×255 samples and 3×3 views according to some embodiments. FIG. 21 is an example sub-sampled version 2102 of FIG. 20.

FIG. 22 is an image illustration showing an example sub-sampled lenslet image with 255×85 samples and 1×3 views according to some embodiments. FIG. 22 is an example sub-sampled version 2202 of FIG. 20.

FIG. 23 is an image illustration showing an example sub-sampled lenslet image with 85×85 samples and 1×1 views according to some embodiments. FIG. 23 is an example sub-sampled version 2302 of FIG. 20.

Individual representations for the different lenslet densities shown in FIGS. 21-23 are described based on the lenslet density in the example MPD of Listing 3 according to some embodiments. Within a density, resolution and bitrate representations may exist. A client may select tiles for different lenslet density representations based on criteria outlined earlier.

Listing 3. Example MPD with Different
Lenslet Density Representations

```
<MPD LightFieldLensLet = lenslet density[5,5]”> >
<AdaptationSet id=“Full“ contentType=“LightFieldLensLet” “lenslet
  density=[5,5]”>
  <!-8Kp Representation at 1000 Mbps and 10 second segments -->
  <Representation id=“UHD2″ bandwidth=“1000000000″ width=“7680″
    height=“4320“>
<AdaptationSet id=“Center“ contentType=“SubLenslets” “lenslet
  density=[3,3]”>
  <!-4Kp Representation at 100 Mbps and 10 second segments -->
  <Representation id=“UHD″ bandwidth=“100000000″ width=“3840″
    height=“2160“>
  ...
  <!-1080p Representation at 20 Mbps and 10 second segments -->
  <Representation id=“HD″ bandwidth=“20000000″ width=″1920″
    height=″1080”>
  ...
<AdaptationSet id=“Left” contentType =“SubLenslets” lenslet
  density=[3,1]”>
  <!-8M point Representation at 100 Mbps and 10 second segments -->
  <Representation id=“UHD″ bandwidth=“100000000“>
<AdaptationSet id=“Left” contentType =“SubLenslets” lenslet
  density=[1,1]”>
  <!-8M point Representation at 100 Mbps and 10 second segments -->
  <Representation id=“UHD″ bandwidth=“100000000“>
  ...
```

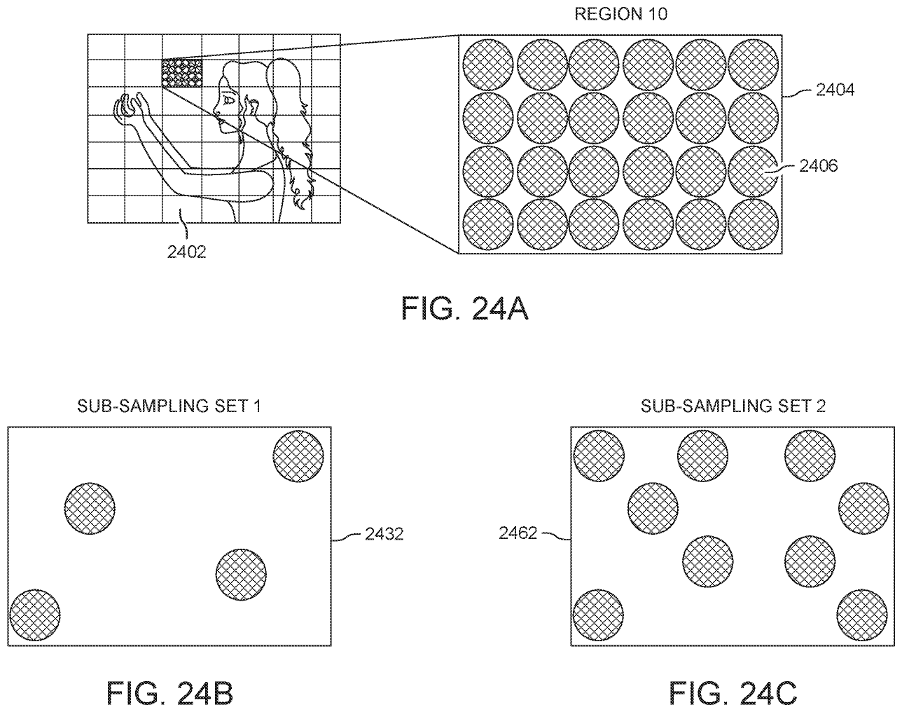

FIGS. 24A-C are schematic illustrations showing an example lenslet light field sub-sampled with two sub-sampling densities according to some embodiments. FIG. 24A shows a full lenslet light field image divided into a 7×7 array of regions 2402. For example, region 10, a 6×4 array 2404 of lenslet sub-views is shown. FIG. 24B shows a first sub-sampling set 2432 with a ⅙ sub-sampling density. FIG. 24C shows a second sub-sampling set 2462 with a ⅜ sub-sampling density.

For the exemplary lenslet light field illustrated in FIGS. 24A-24C, a pseudo MPD may have the structure shown in Listing 4 according to some embodiments. The pseudo MPD describes the light field structure in the adaptation set 1 block. Adaptation sets 22 and 23 describe two different sampling sets for region 10. FIG. 24B corresponds to the example Time step 1 under Adaptation set 22. FIG. 24C corresponds to the example Time step 1 under Adaptation set 23. For both of these examples, the (x, y) coordinates use an origin in the upper left corner. The example codecs listed below have different names for the codecs, though codecs with different names could use the same codec (e.g., “codec 5” and “codec 4” shown below could use the same codec).

Listing 4. Example MPD

```
Period
  Adaptation set 1: Light field scene description:
      Full lenslet light field resolution, definition of regions,
        regions specifications: original resolution, number and
        locations of lenslet images, angular resolution of lenslet
        images. List of regions and available sub-sampling sets for
        each region.
      . . .
  Adaptation set 22: Region 10, sub-sampling set 1 (2 x 2 lenslet
    sampling)
      Mapping metadata: file containing time stamped coordinate
        transformations that map lenslet images from the packed
        lenslet light field of the sub-sampling set to the original
        lenslet image locations in the full lenslet light field.
        Pseudo example of the data:
          Resolution 1
              Individual sample size in pixels: 16 x 16 pixels
          Resolution 2
              Individual sample size in pixels: 12 x 12 pixels
          Time step 1
              Packed location 1, 1 Original location 6, 1
              Packed location 2, 1 Original location 2, 2
              Packed location 1, 2 Original location 5, 3
              Packed location 2, 2 Original location 1, 4
          Time step 2
              Packed location 1, 1 Original location 4, 1
              Packed location 2, 1 Original location 3, 2
              Packed location 1, 2 Original location 5, 2
              Packed location 2, 2 Original location 5, 3
          . . .
      Resolution 1: 1024 x 768 px
          Bitrate 1: Encoded with codec 5, required transfer
            capacity 5 Mbps
          Bitrate 2: Encoded with codec 4, required transfer
            capacity 4 Mbps
      Resolution 2: 800 x 600 px
          Bitrate 1: Encoded with codec 3, required transfer
            capacity 3 Mbps
          Bitrate 2: Encoded with codec 2, required transfer
            capacity 2 Mbps
  Adaptation set 23: Region 10, sub-sampling set 2 (3 x 3 lenslet
    sampling)
      Mapping metadata: file containing time stamped coordinate
        transformations that map lenslet images from the packed
        lenslet light field of the sub-sampling set to the original
        lenslet image location in the full lenslet light field.
        Pseudo example of the data:
          Resolution 1
              Individual sample size in pixels: 15 x 15 pixels
          Resolution 2
              Individual sample size in pixels: 11 x 11 pixels
          Time step 1
              Packed location 1, 1 Original location 1, 1
              Packed location 2, 1 Original location 3, 1
              Packed location 3, 1 Original location 5, 1
              Packed location 1, 2 Original location 2, 2
              Packed location 2, 2 Original location 6, 2
              Packed location 3, 2 Original location 3, 3
              Packed location 1, 3 Original location 5, 3
              Packed location 2, 3 Original location 1, 4
              Packed location 3, 3 Original location 6, 4
          Time step 2
              Packed location 1, 1 Original location 2, 1
              Packed location 2, 1 Original location 4, 1
              Packed location 3, 1 Original location 5, 1
              Packed location 1, 2 Original location 4, 2
              Packed location 2, 2 Original location 6, 2
              Packed location 3, 2 Original location 1, 3
              Packed location 1, 3 Original location 4, 3
              Packed location 2, 3 Original location 6, 3
              Packed location 3, 3 Original location 5, 4
          . . .
      Resolution 1: 1920 x 1080 px
          Bitrate 1: Encoded with codec 9, required transfer
            capacity 9 Mbps
          Bitrate 2: Encoded with codec 8, required transfer
            capacity 8 Mbps
      Resolution 2: 1280 x 720 px per sub-view
          Bitrate 1: Encoded with codec 6, required transfer
            capacity 6 Mbps
        Bitrate 2: Encoded with codec 5, required transfer
            capacity 5 Mbps
      . . .
```

For some embodiments, a description of a lenslet representation (which may be part of the MPD or a manifest file) may include information regarding at least one of range and density of the lenslet representation. For some embodiments, interpolating views from a sub-sampled lenslet representation may use the description of the lenslet representation in the manifest file. For some embodiments, selecting a sub-sampled lenslet representation includes selecting a sub-sampled lenslet representation with the highest range. For some embodiments, selecting the sub-sampled lenslet representation includes selecting a sub-sampled lenslet representation with the highest density. For some embodiments, selecting a sub-sampled lenslet representation selects the sub-sampled lenslet representation based on at least one of: a density of the selected sub-sampled lenslet representation, or a range of the selected sub-sampled lenslet representation.

For some embodiments, a process may include selecting a light field spatial resolution; dividing the light field content into portions corresponding to the light field spatial resolution; and selecting a lenslet image for at least one frame of at least one sub-sampling lenslet representation of at least one portion of the light field content, such that selecting the sub-sampled lenslet representation selects a respective sub-sampling lenslet representation for at least one portion of the light field content, and such that interpolating views from the sub-sampled lenslet representation uses the respective lenslet image.

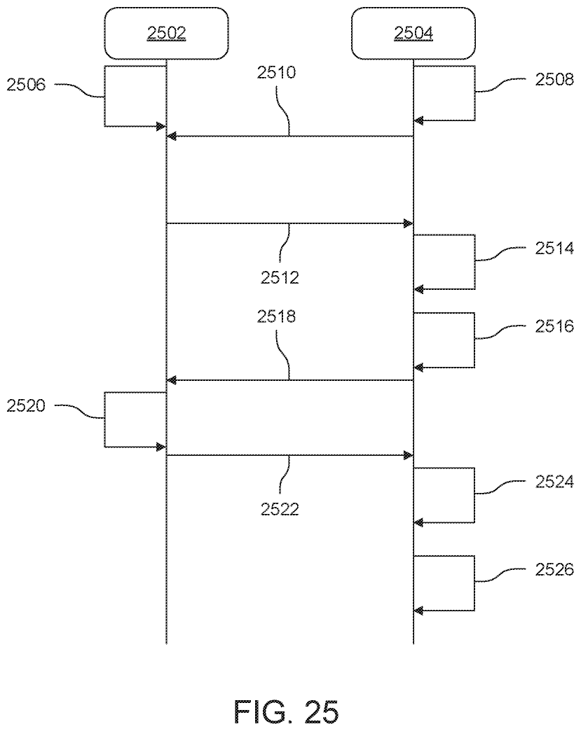

FIG. 25 is a message sequencing diagram illustrating an example process for adaptive light field streaming using estimated bandwidth and view interpolation according to some embodiments. For some embodiments, an example process may include a content server 2502 generating 2506 sub-sampled lenslet representations and a descriptive MPD. For some embodiments, the example process may further include a viewing client 2504 tracking 2508 viewer gaze (or user location, device location, or eye position). For some embodiments, the example process may further include the client 2504 sending 2510 a content request to the content server 2502. For some embodiments, the example process may further include the content server 2502 responding 2512 with an MPD. For some embodiments, the example process may further include the client 2504 estimating 2514 bandwidth available and/or predicted to be used by the requested content. For some embodiments, estimating bandwidth may include determining an estimated bandwidth available for streaming light field video content. For some embodiments, the example process may further include the viewing client 2504 selecting 2516 a lenslet representation. For some embodiments, the example process may further include the viewing client sending 2518 a light field representation request to the content server 2502. For some embodiments, the example process may further include the content server 2502 retrieving 2520 and transmitting 2522 the requested representation segments to the viewing client 2504. For some embodiments, the example process may further include the viewing client 2504 interpolating 2524 views of the content to fill in for views not transmitted to the viewing client. For some embodiments, the example process may further include the viewing client 2504 displaying 2526 the light field for the full light field image and/or frame.

For some embodiments, selecting a lenslet representation (which may be a sub-sampled lenslet representation) may be based on at least one of: a viewpoint of a user, an estimated bandwidth, or a display capability of a viewing client. For some embodiments, a viewing client may retrieve a media manifest file describing a plurality of lenslet representations of portions of light field video content; and may display a set of interpolated views. For some embodiments, a viewing client may determine an estimated bandwidth between a client and a server, wherein selecting the lenslet representation may use the estimated bandwidth. For some embodiments, a viewing client may determine an estimated bandwidth available for streaming light field video content, such that selecting the lenslet representation may select one of the plurality of lenslet representations with a content size less than the estimated bandwidth. For some embodiments, a viewing client may track a direction of gaze of a user, such that selecting the lenslet representation may use the direction of gaze of the user. For some embodiments, a viewing client may estimate bandwidth available for streaming light field video content, such that selecting the sub-sampling rate uses the estimated bandwidth available. For some embodiments, a viewing client may determine a respective minimum supported bandwidth for each of a plurality of sub-sampled lenslet representations. The viewing client may select the sub-sampled lenslet representation with the largest minimum supported bandwidth that is less than the estimated bandwidth. For some embodiments, selecting a sub-sampled lenslet representation includes selecting a sub-sampled lenslet representation with a density above a threshold for portions of the light field content located within a threshold of the direction of gaze of the user. For example, portions of a light field image closer to the gaze of the user may be represented with sub-sampling representation that have a higher light density than portions of the light field image that are further away from the gaze of the user. For some embodiments, selecting a sub-sampled lenslet representation includes selecting a sub-sampled lenslet representation with a density above a threshold for portions of the light field content located within a threshold of the predicted viewpoint.

For some embodiments, a viewing client may select a lenslet image for each frame of each sub-sampling lenslet representation of each portion of the light field content, such that selecting the lenslet representation from the plurality of lenslet representations selects a respective sub-sampling lenslet representation for each portion of the light field content, and such that interpolating views from the sub-sampled lenslet representation uses the respective lenslet image. For some embodiments, selecting alenslet image may select the lenslet image from a plurality of lenslet images that produces optimal interpolation results. For some embodiments, selecting a lenslet image may select the lenslet image from a plurality of lenslet images based on a parameter corresponding to quality of interpolation results. For some embodiments, the viewpoint of the user may be predicted (e.g., by the viewing client based on a tracked viewer gaze). For some embodiments, an estimated maximum content size supported by the estimated bandwidth may be determined. A sub-sampled lenslet representation may be selected such that the representation has a content size less than an estimated maximum content size. For some embodiments, the lenslet representation selected may be adjusted based on a predicted viewpoint of the user.

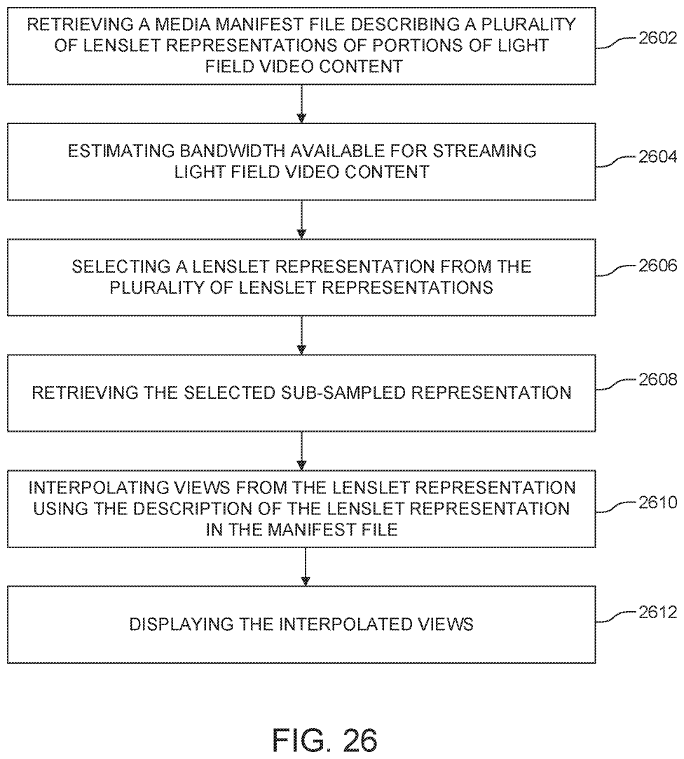

FIG. 26 is a flowchart illustrating an example process for a viewing client according to some embodiments. For some embodiments, an example process may include retrieving 2602 a media manifest file describing a plurality of lenslet representations of portions of light field video content. For some embodiments, the example process may further include estimating 2604 bandwidth available for streaming light field video content. For some embodiments, the example process may further include selecting 2606 a lenslet representation from the plurality of lenslet representations. For some embodiments, the example process may further include retrieving 2608 the selected sub-sampled representation. For some embodiments, the example process may further include interpolating 2610 views from the lenslet representation using the description of the lenslet representation in the manifest file. For some embodiments, the example process may further include displaying 2612 the interpolated views.

For some embodiments, retrieving a media manifest file may include requesting light field video content from a server. For some embodiments, retrieving the selected sub-sampled representation may include requesting the selected sub-sampled representation and receiving the sub-sampled representation. For some embodiments, retrieving the sub-sampled representation may retrieve the sub-sampled representation from a server. For some embodiments, another example process may include: selecting a lenslet representation from a plurality of lenslet representations of portions of light field content described in a media manifest file; retrieving, from a server, a sub-sampled lenslet representation of the selected lenslet representation; and interpolating views from the sub-sampled lenslet representation. For some embodiments, an example method may include: streaming a light field lenslet representation of light field video content; and changing resolution of the light field lenslet representation. For some embodiments, an example method may include: selecting a lenslet representation from a plurality of lenslet representations of portions of light field content; retrieving a sub-sampled lenslet representation of the selected lenslet representation; and interpolating views from the sub-sampled lenslet representation. For some embodiments, an apparatus may include a processor and a non-transitory computer-readable medium storing instructions that are operative, when executed by the processor, to perform one or more of the methods described above.

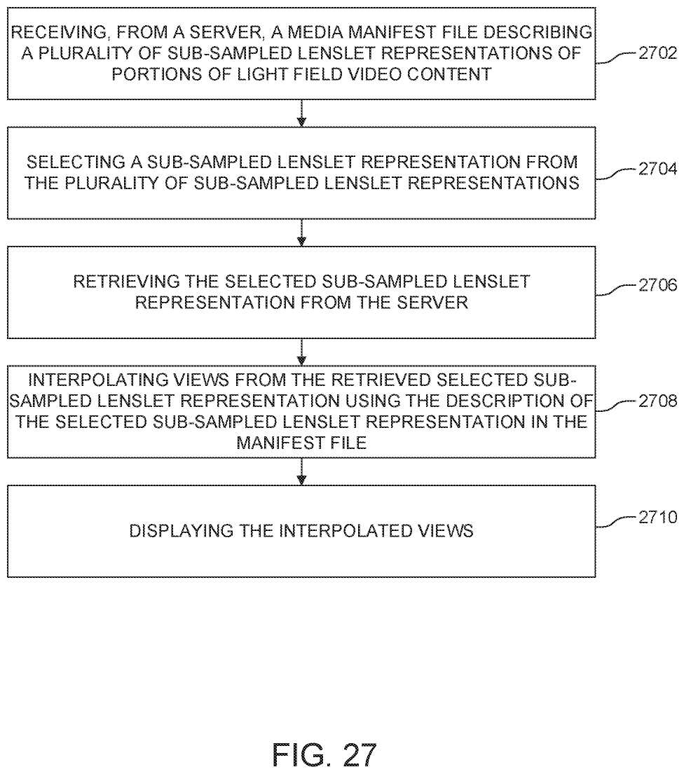

FIG. 27 is a flowchart illustrating an example process for a viewing client according to some embodiments. For some embodiments, an example process may include receiving 2702, from a server, a media manifest file describing a plurality of sub-sampled lenslet representations of portions of light field video content. For some embodiments, the example process may further include selecting 2704 a sub-sampled lenslet representation from the plurality of sub-sampled lenslet representations. For some embodiments, the example process may further include retrieving 2706 the selected sub-sampled lenslet representation from the server. For some embodiments, the example process may further include interpolating 2708 views from the retrieved selected sub-sampled lenslet representation using the description of the selected sub-sampled lenslet representation in the manifest file. For some embodiments, the example process may further include displaying 2710 the interpolated views.

While the methods and systems in accordance with some embodiments are discussed in the context of virtual reality (VR), some embodiments may be applied to mixed reality (MR)/augmented reality (AR) contexts as well. Also, although the term “head mounted display (HMD)” is used herein in accordance with some embodiments, some embodiments may be applied to a wearable device (which may or may not be attached to the head) capable of, e.g., VR, AR, and/or MR for some embodiments.

An example method in accordance with some embodiments may include: requesting light field video content from a server; receiving a media manifest file describing a plurality of lenslet representations of portions of the light field content; determining an estimated bandwidth available for streaming the light field video content; selecting a sub-sampled lenslet representation from the plurality of sub-sampled lenslet representations; requesting the selected sub-sampled lenslet representation from a server; receiving the sub-sampled representation; interpolating views from the received sub-sampled lenslet representation using the description of the lenslet representation in the manifest file; and displaying the interpolated views.

For some embodiments of the example method, selecting the sub-sampled lenslet representation selects the sub-sampled lenslet representation based on the estimated bandwidth.

For some embodiments of the example method, selecting the sub-sampled lenslet representation may include: determining a respective minimum supported bandwidth for each of the plurality of sub-sampled lenslet representations; and selecting the sub-sampled lenslet representation with a largest minimum supported bandwidth of the plurality of respective minimum supported bandwidths less than the estimated bandwidth.

An example method in accordance with some embodiments may include: retrieving a media manifest file describing a plurality of lenslet representations of portions of light field video content; selecting a lenslet representation from the plurality of lenslet representations; retrieving the selected sub-sampled representation; interpolating views from the retrieved sub-sampled lenslet representation using the description of the lenslet representation in the manifest file; and displaying the interpolated views.

An example method in accordance with some embodiments may include: selecting a lenslet representation from a plurality of lenslet representations of portions of light field content described in a media manifest file; retrieving, from a server, a sub-sampled lenslet representation of the selected lenslet representation; and interpolating views from the sub-sampled lenslet representation.

Some embodiments of the example method may further include: retrieving a media manifest file describing a plurality of lenslet representations of portions of light field video content; and displaying the interpolated views.

Some embodiments of the example method may further include: determining an estimated bandwidth between a client and a server, wherein selecting the lenslet representation uses the estimated bandwidth.

Some embodiments of the example method may further include: determining an estimated bandwidth available for streaming light field video content; and determining an estimated maximum content size supported by the estimated bandwidth, wherein selecting the lenslet representation selects one of the plurality of lenslet representations with a content size less than the estimated maximum content size.

For some embodiments of the example method, the description of at least one of the plurality of lenslet representations may include information regarding at least one of range or density of the respective lenslet representation.

For some embodiments of the example method, selecting the sub-sampled lenslet representation may include selecting a sub-sampled lenslet representation with a highest range.

For some embodiments of the example method, selecting the sub-sampled lenslet representation may include selecting a sub-sampled lenslet representation with a highest density.

Some embodiments of the example method may further include: tracking a direction of gaze of a user, wherein selecting the lenslet representation may use the direction of gaze of the user.

For some embodiments of the example method, selecting the sub-sampled lenslet representation may include selecting a sub-sampled lenslet representation with a density above a threshold for portions of the light field content located within a threshold of the direction of gaze of the user

For some embodiments of the example method, selecting the lenslet representation may use a capability of a client.

For some embodiments of the example method, selecting the sub-sampled lenslet representation may include selecting a sub-sampled lenslet representation with a density above a threshold supported by the client.

For some embodiments of the example method, the capability of the client may be a maximum lenslet density supported by the client.

For some embodiments of the example method, wherein interpolating views from the sub-sampled lenslet representation may use the description of the lenslet representation in the manifest file.

Some embodiments of the example method may further include: updating a viewpoint of a user; and adjusting the selected lenslet representation for the updated viewpoint.

Some embodiments of the example method may further include: predicting a viewpoint of the user; and adjusting the selected lenslet representation for the predicted viewpoint.

Some embodiments of the example method may further include selecting a sub-sampling rate for the selected lenslet representation, wherein selecting the sub-sampling rate may use the predicted viewpoint.

For some embodiments of the example method, selecting the sub-sampled lenslet representation may include selecting a sub-sampled lenslet representation with a density above a threshold for portions of the light field content located within a threshold of the predicted viewpoint.

Some embodiments of the example method may further include selecting a sub-sampling rate for the selected lenslet representation.

Some embodiments of the example method may further include estimating bandwidth available for streaming light field video content, wherein selecting the sub-sampling rate may use the estimated bandwidth available.

Some embodiments of the example method may further include: selecting light field spatial resolution; and dividing the light field content into portions corresponding to the selected light field spatial resolution.

Some embodiments of the example method may further include adjusting light field spatial resolution to improve a performance metric of the interpolated views.

Some embodiments of the example method may further include selecting a lenslet image for each frame of each sub-sampling lenslet representation of each portion of the light field content, wherein selecting the lenslet representation from the plurality of lenslet representations may select a respective sub-sampling lenslet representation for each portion of the light field content, and wherein interpolating views from the sub-sampled lenslet representation may use the respective lenslet image.

For some embodiments of the example method, selecting the lenslet image may select the lenslet image from a plurality of lenslet images that produces optimal interpolation results.

For some embodiments of the example method, interpolating views from the retrieved sub-sampled lenslet representation using the description of the lenslet representation in the manifest file may include: unpacking the retrieved sub-sampled lenslet representation into original lenslet locations of the portion of light field video content indicated in the manifest file; and interpolating lenslet samples omitted from the retrieved sub-sampled lenslet representation.

For some embodiments of the example method, interpolating views from the retrieved sub-sampled lenslet representation generates a complete light field region image for the portion of the light field video content.

An example apparatus in accordance with some embodiments may include: a processor; and a non-transitory computer-readable medium storing instructions that are operative, when executed by the processor, to perform any of the example methods listed above.

Another example method in accordance with some embodiments may include: streaming a light field lenslet representation of light field video content; and changing resolution of the light field lenslet representation.

An additional example method in accordance with some embodiments may include: selecting a lenslet representation from a plurality of lenslet representations of portions of light field content; retrieving a sub-sampled lenslet representation of the selected lenslet representation; and interpolating views from the sub-sampled lenslet representation to reconstruct lenslet samples missing in the sub-sampled representation.

A further additional example method in accordance with some embodiments may include: retrieving a sub-sampled lenslet representation of light field content; and reconstructing lenslet samples omitted from the sub-sampled lenslet representation by interpolating the retrieved sub-sampled lenslet representation.

An example method in accordance with some embodiments may include: receiving, from a server, a media manifest file describing a plurality of sub-sampled lenslet representations of portions of light field video content; selecting a sub-sampled lenslet representation from the plurality of sub-sampled lenslet representations; retrieving the selected sub-sampled lenslet representation from the server; interpolating views from the retrieved selected sub-sampled lenslet representation using the description of the selected sub-sampled lenslet representation in the manifest file; and displaying the interpolated views.

Some embodiments of the example method may further include determining an estimated bandwidth available for streaming the light field video content.

For some embodiments of the example method, selecting the sub-sampled lenslet representation may select the sub-sampled lenslet representation based on at least one of: a viewpoint of a user, an estimated bandwidth, or a display capability of a viewing client.

Some embodiments of the example method may further include predicting a predicted viewpoint of the user, such that the viewpoint of the user is the predicted viewpoint of the user.

For some embodiments of the example method, selecting the sub-sampled lenslet representation may include: determining a respective minimum supported bandwidth for at least one of the plurality of sub-sampled lenslet representations; and selecting the sub-sampled lenslet representation with a largest minimum supported bandwidth of the plurality of respective minimum supported bandwidths less than the estimated bandwidth.

Some embodiments of the example method may further include determining an estimated maximum content size supported by the estimated bandwidth, such that selecting the sub-sampled lenslet representation may select one of the plurality of sub-sampled lenslet representations with a content size less than the estimated maximum content size.

Some embodiments of the example method may further include: tracking a direction of gaze of a user, such that selecting the sub-sampled lenslet representation uses the direction of gaze of the user.

For some embodiments of the example method, selecting the sub-sampled lenslet representation may include selecting a sub-sampled lenslet representation with a density above a density threshold for portions of the light field content located within a gaze threshold of the direction of gaze of the user.

Some embodiments of the example method may further include: predicting a viewpoint of a user; and adjusting the selected lenslet representation for the predicted viewpoint.

Some embodiments of the example method may further include: selecting a light field spatial resolution; dividing the light field content into portions corresponding to the light field spatial resolution; and selecting a lenslet image for at least one frame of at least one sub-sampling lenslet representation of at least one portion of the light field content, such that selecting the sub-sampled lenslet representation may select a respective sub-sampling lenslet representation for at least one portion of the light field content, and such that interpolating views from the sub-sampled lenslet representation may use the respective lenslet image.

Some embodiments of the example method may further include adjusting the light field spatial resolution to improve a performance metric of the interpolated views.

For some embodiments of the example method, interpolating views from the retrieved sub-sampled lenslet representation may include: unpacking the retrieved sub-sampled lenslet representation into original lenslet locations of the portion of light field video content indicated in the manifest file; and interpolating lenslet samples omitted from the retrieved sub-sampled lenslet representation.

For some embodiments of the example method, interpolating views from the retrieved sub-sampled lenslet representation may generate a complete light field region image for the portion of the light field video content.

For some embodiments of the example method, selecting the sub-sampled lenslet representation may select the sub-sampled lenslet representation based on at least one of: a density of the selected sub-sampled lenslet representation, or a range of the selected sub-sampled lenslet representation.

An example apparatus in accordance with some embodiments may include: a processor; and a non-transitory computer-readable medium storing instructions that are operative, when executed by the processor, to perform the method of any one of claims listed above.

An example method in accordance with some embodiments may include: selecting a lenslet representation from a plurality of lenslet representations of portions of light field content described in a media manifest file; retrieving, from a server, a sub-sampled lenslet representation of the selected lenslet representation; and interpolating views from the sub-sampled lenslet representation.

Some embodiments of the example method may further include: retrieving a media manifest file describing a plurality of lenslet representations of portions of light field video content; and displaying the interpolated views.

For some embodiments of the example method, interpolating the views from the retrieved sub-sampled lenslet representation may use the description of the lenslet representation in the manifest file.

Some embodiments of the example method may further include: determining an estimated bandwidth between a client and a server, such that selecting the lenslet representation may use the estimated bandwidth.

For some embodiments of the example method, the description of at least one of the plurality of lenslet representations may include information regarding at least one of range or density of the respective lenslet representation.

For some embodiments of the example method, selecting the sub-sampled lenslet representation may include selecting a sub-sampled lenslet representation with a highest range.

For some embodiments of the example method, selecting the sub-sampled lenslet representation may include selecting a sub-sampled lenslet representation with a highest density.

For some embodiments of the example method, selecting the lenslet representation may use a capability of a client.

For some embodiments of the example method, selecting the sub-sampled lenslet representation may include selecting a sub-sampled lenslet representation with a density above a threshold supported by the client.

For some embodiments of the example method, the capability of the client may be a maximum lenslet density supported by the client.

For some embodiments of the example method, interpolating views from the sub-sampled lenslet representation may use the description of the lenslet representation in the manifest file.

Some embodiments of the example method may further include: updating a viewpoint of a user; and adjusting the selected lenslet representation for the updated viewpoint.

Some embodiments of the example method may further include: predicting a viewpoint of the user, such that selecting the sub-sampled lenslet representation may include selecting a sub-sampled lenslet representation with a density above a threshold for portions of the light field content located within a threshold of the predicted viewpoint.

Some embodiments of the example method may further include selecting a sub-sampling rate for the selected lenslet representation.

Some embodiments of the example method may further include estimating bandwidth available for streaming light field video content, such that selecting the sub-sampling rate may use the estimated bandwidth available.

Some embodiments of the example method may further include: selecting a lenslet image for each frame of each sub-sampling lenslet representation of each portion of the light field content, such that selecting the lenslet representation from the plurality of lenslet representations selects a respective sub-sampling lenslet representation for each portion of the light field content, such that interpolating views from the sub-sampled lenslet representation uses the respective lenslet image, and such that selecting the lenslet image selects the lenslet image from a plurality of lenslet images based on an estimated quality of interpolation results.

Some embodiments of the example method may further include determining a respective estimated quality of interpolation results for the plurality of lenslet images, such that selecting the lenslet image selects the lenslet image based on which lenslet image of the plurality of lenslet images has a highest determined respective estimated quality of interpolation results.

An example apparatus in accordance with some embodiments may include: a processor; and a non-transitory computer-readable medium storing instructions that are operative, when executed by the processor, to perform any of the methods listed above.

An example method in accordance with some embodiments may include: streaming a light field lenslet representation of light field video content; and changing resolution of the light field lenslet representation.

An example apparatus in accordance with some embodiments may include: a processor; and a non-transitory computer-readable medium storing instructions that are operative, when executed by the processor, to perform any of the methods listed above.

An example method in accordance with some embodiments may include: selecting a lenslet representation from a plurality of lenslet representations of portions of light field content; retrieving a sub-sampled lenslet representation of the selected lenslet representation; and interpolating views from the sub-sampled lenslet representation to reconstruct lenslet samples missing in the sub-sampled representation.

An example apparatus in accordance with some embodiments may include: a processor; and a non-transitory computer-readable medium storing instructions that are operative, when executed by the processor, to perform any of the methods listed above.

An example method in accordance with some embodiments may include: retrieving a sub-sampled lenslet representation of light field content; and reconstructing lenslet samples omitted from the sub-sampled lenslet representation by interpolating the retrieved sub-sampled lenslet representation.

An example apparatus in accordance with some embodiments may include: a processor; and a non-transitory computer-readable medium storing instructions that are operative, when executed by the processor, to perform any of the methods listed above.

An example method in accordance with some embodiments may include: sending a media manifest file describing a plurality of sub-sampled lenslet representations of portions of light field video content; receiving information indicating a sub-sampled lenslet representation selected from the plurality of sub-sampled lenslet representations; and sending the selected sub-sampled lenslet representation.

An example apparatus in accordance with some embodiments may include: a processor; and a non-transitory computer-readable medium storing instructions that are operative, when executed by the processor, to perform any of the methods listed above.

An example apparatus in accordance with some embodiments may include: a processor; and a non-transitory computer-readable medium storing instructions that are operative, when executed by the processor, to: send a media manifest file describing a plurality of sub-sampled lenslet representations of portions of light field video content; receive information indicating a sub-sampled lenslet representation selected from the plurality of sub-sampled lenslet representations; and send the selected sub-sampled lenslet representation.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
receiving, from a server, a media manifest file describing a plurality of sub-sampled lenslet representations of portions of light field video content;
selecting a sub-sampled lenslet representation from the plurality of sub-sampled lenslet representations;
retrieving the selected sub-sampled lenslet representation from the server;
interpolating views from the retrieved selected sub-sampled lenslet representation using the description of the selected sub-sampled lenslet representation in the manifest file; and
displaying the interpolated views.

2. The method of claim 1, further comprising determining an estimated bandwidth available for streaming the light field video content.

3. The method of claim 1, wherein selecting the sub-sampled lenslet representation selects the sub-sampled lenslet representation based on at least one of: a viewpoint of a user, an estimated bandwidth, or a display capability of a viewing client.

4. The method of claim 3,
further comprising predicting a predicted viewpoint of the user,
wherein the viewpoint of the user is the predicted viewpoint of the user.

5. The method of claim 3, wherein selecting the sub-sampled lenslet representation comprises:
determining a respective minimum supported bandwidth for at least one of the plurality of sub-sampled lenslet representations; and
selecting the sub-sampled lenslet representation with a largest minimum supported bandwidth of the plurality of respective minimum supported bandwidths less than the estimated bandwidth.

6. The method of claim 3, further comprising:
determining an estimated maximum content size supported by the estimated bandwidth,
wherein selecting the sub-sampled lenslet representation selects one of the plurality of sub-sampled lenslet representations with a content size less than the estimated maximum content size.

7. The method of claim 1, further comprising:
tracking a direction of gaze of a user,
wherein selecting the sub-sampled lenslet representation uses the direction of gaze of the user.

8. The method of claim 7, wherein selecting the sub-sampled lenslet representation comprises selecting a sub-sampled lenslet representation with a density above a density threshold for portions of the light field video content located within a gaze threshold of the direction of gaze of the user.

9. The method of claim 1, further comprising:
predicting a viewpoint of a user; and
adjusting the selected lenslet representation for the predicted viewpoint.

10. The method of claim 1, further comprising:
selecting a light field spatial resolution;
dividing the light field video content into portions corresponding to the light field spatial resolution; and
selecting a lenslet image for at least one frame of at least one sub-sampling lenslet representation of at least one portion of the light field video content,
wherein selecting the sub-sampled lenslet representation selects a respective sub-sampling lenslet representation for at least one portion of the light field video content, and
wherein interpolating views from the sub-sampled lenslet representation uses the respective lenslet image.

11. The method of claim 10, further comprising adjusting the light field spatial resolution to improve a performance metric of the interpolated views.

12. The method of claim 1, wherein interpolating views from the retrieved sub-sampled lenslet representation comprises:
unpacking the retrieved sub-sampled lenslet representation into original lenslet locations of the portion of light field video content indicated in the manifest file; and
interpolating lenslet samples omitted from the retrieved sub-sampled lenslet representation.

13. The method of claim 1, wherein interpolating views from the retrieved sub-sampled lenslet representation generates a complete light field region image for the portion of the light field video content.

14. The method of claim 1, wherein selecting the sub-sampled lenslet representation selects the sub-sampled lenslet representation based on at least one of: a density of the selected sub-sampled lenslet representation, or a range of the selected sub-sampled lenslet representation.

15. An apparatus comprising:
a processor; and
a non-transitory computer-readable medium storing instructions operative, when executed by the processor, to cause the apparatus to:
receive, from a server, a media manifest file describing a plurality of sub-sampled lenslet representations of portions of light field video content;
select a sub-sampled lenslet representation from the plurality of sub-sampled lenslet representations;
retrieve the selected sub-sampled lenslet representation from the server;
interpolate views from the retrieved selected sub-sampled lenslet representation using the description of the selected sub-sampled lenslet representation in the manifest file; and
display the interpolated views.

16. A method comprising:
selecting a lenslet representation from a plurality of lenslet representations of portions of light field video content described in a media manifest file;
retrieving, from a server, a sub-sampled lenslet representation of the selected lenslet representation; and
interpolating views from the sub-sampled lenslet representation.

17.-18. (canceled)

19. The method of claim 16, further comprising:
determining an estimated bandwidth between a client and a server,
wherein selecting the lenslet representation uses the estimated bandwidth.

20.-26. (canceled)

27. The method of claim 16, further comprising:
updating a viewpoint of a user; and
adjusting the selected lenslet representation for the updated viewpoint.

28. The method of claim 16, further comprising:
predicting a viewpoint of the user,
wherein selecting the sub-sampled lenslet representation comprises selecting a sub-sampled lenslet representation with a density above a threshold for portions of the light field video content located within a threshold of the predicted viewpoint.

29.-30. (canceled)

31. The method of claim 16, further comprising:
selecting a lenslet image for each frame of each sub-sampling lenslet representation of each portion of the light field video content,
wherein selecting the lenslet representation from the plurality of lenslet representations selects a respective sub-sampling lenslet representation for each portion of the light field video content,
wherein interpolating views from the sub-sampled lenslet representation uses the respective lenslet image, and
wherein selecting the lenslet image selects the lenslet image from a plurality of lenslet images based on an estimated quality of interpolation results.

32.-42. (canceled)
